(19) United States
(12) Patent Application Publication
(10) Pub. No.: US 2004/0153424 A1
(43) Pub. Date: Aug. 5, 2004

(54) Methods, systems, and computer-readable products for allocating shipment cost to cost center using procurement card

(76) Inventors: Tracy M. Lussow, Wauwatosa, WI (US); George Doome II, Milwaukee, WI (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/423,613

(22) Filed: Apr. 24, 2003

Related U.S. Application Data
(60) Provisional application No. 60/444,842, filed on Feb. 3, 2003.

(51) Int. Cl. G06F 17/60

(52) U.S. Cl. 705/400

(57) ABSTRACT

The systems, methods, and computer-readable media disclosed herein can be used to charge the cost of shipment of a package to an appropriate cost center and sub-category thereof through the use of a procurement card. Upon receiving an invoice from a procurement card provider, the sender of a package has all data required to pay for the cost of shipment from an appropriate cost center due to a series of data relationships stored by a carrier computer system, the procurement card provider, and/or possibly third party data processors participating in a shipment transaction.

### CROSS-REFERENCE TO RELATED APPLICATION

This patent application is a U.S. nonprovisional application filed pursuant to Title 35, United States Code §§ 100 et seq. and 37 C.F.R. Section 1.53(b) claiming priority under Title 35, United States Code §119(e) to U.S. provisional application No. 60/444,842 filed Feb. 3, 2003 naming Tracy Lussow and George Doome as inventors. Both the subject application and its provisional application have been or are under obligation to be assigned to the same entity.

### BACKGROUND OF THE INVENTION

1. Field of the Invention

The invention relates to shipment of packages at entities such as universities, colleges, or other government-funded institutions at which accounting requirements relating to shipment costs are generally stringent due to government regulation and policies. The invention also relates to using procurement cards to pay for package shipment costs. The invention further relates to using browser-based interfaces and applications to ship packages via the Internet or other public network.

2. Description of the Related Art

Like many businesses, universities, colleges, laboratories, and other such institutions, are generally high-volume users of shipping services. Such institutions use shipping services to transmit letters, documents, texts, materials, and other items necessary in the conduct of their work. At the typical institution, the number of shipments made each year may be on the order of tens to hundreds of thousands, so shipment services are a substantial expense for such institutions.

Tracking charges for shipments and applying such charges to appropriate cost centers or budget strings for accounting purposes has long been a challenge to users, accounting departments, and others within such institutions. Although the expense for a shipment is relatively small in monetary amount on a per package basis, when shipment charges are added over the users, groups and departments, or locations within an institution, such charges can be significant. It is the relatively low cost per package, but high frequency at which shipment expenses are incurred, that has made shipment charges particularly difficult for institutions to track for accounting purposes for application to the cost center to which such shipment charges pertain.

Conventional techniques for tracking shipment charges include use of a purchase order or requisition, direct pay invoices in which the recipient of the package pre-pays for the shipment costs, check requests, petty cash transactions, and personal reimbursements. These techniques all impose on users of shipping services the time and trouble required to fill out appropriate paper work that identifies the cost center to which the shipping charge applies, and to forward such paperwork to the accounting department. At the accounting department, such paperwork must be processed, typically by hand, to assign the shipment cost to the appropriate cost center, and to make payment to the shipper from the appropriate cost center. The time, expense, and aggravation required of the user and the accounting personnel to employ these techniques to appropriately account for shipment charges can far exceed the expense of the shipment charge itself. But given the stringent accounting requirements imposed on many such institutions by government regulation, shipment charges must nonetheless be tracked and applied to appropriate cost centers so that accounting records related to these charges will be sufficiently detailed to withstand government audit. Even with such stringent controls, users of shipping services often fail to identify sufficient information on the paperwork submitted to the accounting department to achieve appropriate application of the charge to the related cost center. The result is that numerous shipping charges are applied to ‘general ledger’ or ‘miscellaneous’ cost centers. Not only does this situation result in loss of important information as to what users, departments, or locations within an institution are incurring shipping charges for purposes of management of the institution, but also, in those situations where the shipping charges are reimbursable to the institution, this fact is lost due to missing information in the paperwork submitted to its accounting department. As a result, the institution may absorb costs for shipments that it should not incur, not to mention spending significant time in attempting to reconcile shipment charges associated with shipment forms and records that have missing or illegible information provided thereon. Given that an average-sized institution sends tens or hundreds of thousands of shipments per year, the expense of unreconciled shipment charges can be a significant drain on an institution's financial resources. It would clearly be desirable to overcome these disadvantages of previous approaches to using and account for charges associated with shipment services.

‘Procurement cards’ are commonly used by universities, colleges, laboratories, hospitals, and other such institutions. Procurement cards are offered by several major credit card companies and banks, including Visa®), Inc., MasterCard®, Inc., and AmericanExpress®), Inc., and many others. Such cards enable card holders to purchase relatively inexpensive products and services on behalf of an institution. The cards are intended to reduce or eliminate use of purchase orders, direct pay invoices, check requests, petty cash transactions, and personal reimbursements on purchases of relatively low monetary amount. The procurement card is generally more restrictive in its terms of use than a credit card, which has a single purchase limit restriction. The procurement card normally has a single purchase amount limit (e.g., $1,500 or $2,500), and in addition, one or more of the following restrictions: limited number of authorizations allowed per day, limited number of transactions allowed per cycle, total spending limit per cycle, and limits to certain merchant category codes (e.g., use of card for meals, travel and entertainment may not be permitted under terms established by the institution for use of the procurement card). Normally, department heads, deans, and directors or trustees of the institution set most of the limits for the a procurement card. The procurement card account is normally opened under the name of a particular individual (e.g., department head, dean, or chair), or a group (e.g., a department within the institution), or a particular location within an institution.

One problem with procurement cards is that they are vulnerable to unauthorized use. In many institutions, procurement cards are used by numerous individuals, and their numbers and expiration dates are recorded and appear on numerous documents. It frequently occurs that the procurement cards are subject to unauthorized or inappropriate use, which causes the institution to incur unnecessary expenses. It would be desirable to overcome this disadvantage of previous techniques.

Considering the above and other facts regarding accounting of shipment charges incurred by institutions, it is clear that there are several disadvantages with the current techniques for accounting for shipment charges within institutions:

(1) conventional paper-based techniques for tracking shipment charges for application to an appropriate cost center require a user to fill out a written form to document shipment charges with sufficient information to enable the charge to be appropriately applied to a cost center within the institution. It would be desirable to eliminate the requirement that users expend significant time and effort to fill out paper forms to ship a package;

(2) paper records are prone to deterioration so that information necessary to relate shipping charges to a particular cost center may be lost. This causes accounting department personnel significant time and effort to contact persons who can supply missing information so that the shipping charge can be applied to the appropriate cost center;

(3) paper records documenting the addressee and cost center to which a shipping charge should be applied are typically hand-written by the users. Often, accounting personnel must spend a significant amount of time attempting to read handwriting that is not clear or is illegible. In the event the handwriting cannot be discerned, accounting personnel expend a significant amount of time in tracking down a user and others with knowledge of the facts surrounding the shipment. In many cases, the paper records have insufficient information for accounting personnel to be able to apply charges correctly. It would be desirable to reduce or eliminate this deficiency of previous methods for applying shipping charges to appropriate cost centers;

(4) In many cases, with a paper-based shipping charge accounting technique, a user is required to fill out information in paper forms that is recurrent from one shipment to the next. For example, if a user intends to ship several different packages to the same addressee, the user must nonetheless repetitively write or type the name of the addressee and sufficient information identifying the associated cost center on several different forms for each of the packages to be shipped. It would be desirable to overcome this deficiency of previous shipping techniques;

(5) At the institution's accounting department, written forms from users of shipping services are manually processed. For an institution of average size, this requires manual processing of tens or hundreds of thousands of forms per year. As a result, the institution is significantly burdened in terms of the labor required to process shipment-related forms for assessment to the appropriate cost center. This imposes a significant burden on an institution's accounting department. It would be desirable to overcome this disadvantage of previous shipping techniques;

(6) If the accounting department cannot determine from the written forms what the cost center is and cannot otherwise contact the user or other person within the institution to determine what cost center to use to apply a shipping charge, then the shipping charge is normally allotted to a ‘general ledger’ or ‘miscellaneous’ category. In those instances in which the shipping charge is payable by a third party, the institution absorbs the shipping charge due to the fact that it lacks sufficient information to apply the charge to a third party. It would be desirable to overcome this disadvantage of previous techniques;

(7) It would be desirable to enhance the overall efficiency and timeliness of processing shipping charges and applying them to an appropriate cost center in the institution. This would decrease time, labor, and aggravation spent on the part of the user and accounting personnel, place the institution in better stead to address an audit, and more rapidly lead to reimbursement of shipping charges from third parties;

(8) It would be desirable to accurately capture information concerning shipping charges for purposes of management of an institution. For example, such information may be used to determine those departments and functions within an institution that require significant support and services related to shipping, and those departments or functions that do not require as much shipping support and services, facts which may be important to locating shipping equipment and personnel within the institution;

(9) It would be desirable to use procurement cards to pay for shipping charges in such a way that the procurement card number and expiration date are not generally exposed to persons that do not need to have such information. This can be used to reduce or eliminate unauthorized use of procurement cards to better control spending under such cards at institutions.

### SUMMARY OF THE INVENTION

The systems, methods, and computer-readable data storage media disclosed herein, in their various embodiments, can be used in the process of associating package shipment cost charged to a procurement card, to an appropriate cost center and subcategory thereof, of a procurement card holder (PCH). The PCH can be an institution as previously described. The disclosed systems, methods, and computer-readable data storage media can be used to associate sender identification (ID) data to cost center ID data. This relationship can be accomplished by intermediate relationships of the sender ID data to carrier account data and procurement card data which identify respective accounts of the carrier and procurement card provider (PCP), respectively. The sender can use reference data to refer to a subcategory of the cost center to which payment for the shipment is to be applied. The reference data can be transmitted from the procurement card holder, through the computer systems of the carrier, PCP, and any third party data processor, back to the PCH in the form of an invoice. Because the invoice can include the cost center ID data and reference data, payment can be made from the appropriate cost center and the payment applied to the appropriate cost center and subcategory thereof by the PCH.

These together with other objectives and advantages of the invention will hereinafter be described in detail in connection with the following drawings in which like numbered elements refer to like parts throughout the several views.

### BRIEF DESCRIPTION OF THE DRAWINGS

FIG. 1 is a schematic diagram of a system and method using a procurement card to pay for shipment charges so that such charges can be applied to associated cost centers of an institution;

FIGS. 2A-2C are a flowchart of a general method of the invention for using a procurement card to apply cost for shipment to an appropriate cost center and subcategory in accordance with the invention;

FIG. 3 is a general schematic diagram of an overall system and method for using a procurement card to apply cost for shipment to an appropriate cost center and subcategory thereof in accordance with the invention;

FIG. 4 is a block diagram of the sender's computer used to request shipment of a package in accordance with the invention;

FIG. 5 is a browser display indicating use of the sender's computer to enter sender ID data into the computer in accordance with the invention;

FIG. 6 is a browser display used by the sender to specify shipment data and reference data in accordance with the invention;

FIG. 7 is a shipment label that can be used by the sender to transmit the package to the recipient using the carrier;

FIGS. 8A and 8B are a flowchart of a method implemented by the sender using the PCH computer system in accordance with the invention;

FIG. 9 is a block diagram of a carrier computer system in accordance with the invention;

FIG. 10 is a schematic block diagram of a more specific embodiment of the carrier computer system;

FIGS. 11A-11S are a flowchart of a method performed by the carrier computer system dance with the invention;

FIG. 12 is a block diagram of a PCP computer system in accordance with the invention;

FIG. 13 is a method performed by the PCP computer system in accordance with the invention;

FIG. 14 is a block diagram of a third party data processor computer system according to the invention;

FIG. 15 is a flowchart of a method performed by the third party data processor, in accordance with the invention;

FIG. 16 is a block diagram of a computer of the PCH used by an accountant to charge the shipment cost to an appropriate cost center and subcategory thereof using the procurement card, in accordance with the invention;

FIGS. 17A-17C are a flowchart of a method implemented by the accountant using the PCH computer system;

FIG. 18 is a browser display of a listing of transaction data for package shipments showing cost data indicating cost of package shipment, and cost center identification data and reference data used to allocate cost of shipment to the appropriate PCH cost center and subcategory thereof; and

FIG. 19 shows Level I, II, and III details provided by major procurement card providers.

### DESCRIPTION OF THE PREFERRED EMBODIMENTS

As used herein, the following words have the following meanings:

“Browser Application” is software executed by a computer to access resources via the World Wide Web, Internet, Internet2, or other such networks. Microsoft® Explorer version 6.x and Netscape® version 7.x are examples of browser applications.

“Input Device” can be a keyboard, mouse, pen, stylus or other device used to input data into a computer.

“Institution” refers to a university, college, or a government-funded entity.

“Memory” refers to read-only memory (ROM), random-access memory (RAM), hard disk data storage unit, and other such devices.

“Operating System” enables a processor to communicate with other elements of a computer. DOS, Windows 2000, Windows NT, OS/2, etc.

“Output Device” refers to a device such as a monitor, for generating a display of a computer.

“Participant” refers to an entity involved in a shipment transaction.

“Processor” can be a microprocessor such as a Pentium® or Xeon® series unit from Intel® Corporation, California, an Athlon® unit from Advanced Micro Devices, Inc., California or other such unit, a microcontroller, programmable logic device, programmable logic array (PLA), programmed array logic (PAL), programmable gate array (PGA), filed programmable gate array (FPGA), or other computing device.

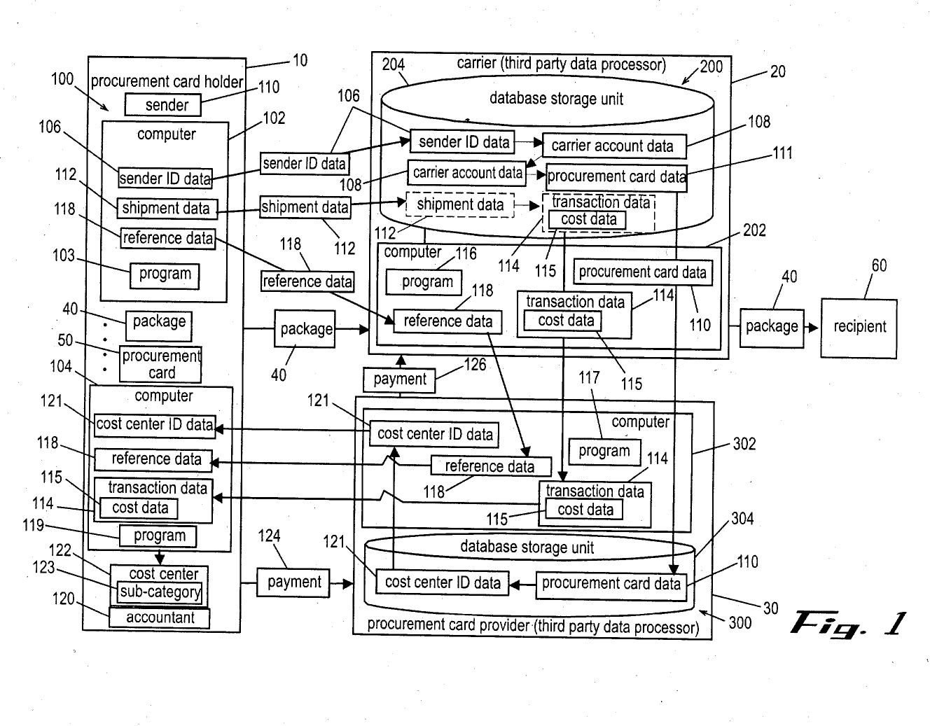

In FIG. 1, participants to a shipment transaction include procurement card holder (“PCH”) 10, carrier 20, and procurement card provider (“PCP”) 30. Each of these participants can be provided with respective computer systems 100, 200, 300. The computer systems 100, 200, 300 can be connected to communicate with one another over a network such as the World Wide Web, Internet, Electronic Data Interchange (EDI) or other such network, whether now existing or to be developed in the future. Computer system 100 comprises computers 102, 104 which can be networked together, but are not required to be so connected. Computer system 200 of carrier 20 comprises at least computer 202 and database storage unit 204. Computer system 300 comprises at least computer 302 and database storage unit 304.

Before initiating the process of shipping a package 40, the PCH 10 has submitted an application to obtain a procurement card 50 from the PCP 30. In the application, the PCH 10 has identified a cost center 122 to be associated with the procurement card 50 issued by the PCP 30. The cost center 122 can be a particular bank account, grant fund, or other source of funds held by the PCH entity or its bank. The PCP 30 stores cost center identification (ID) data 121 identifying the cost center 122, in association with procurement card data 111 in a record of database storage unit 304.

Also before commencement of a shipment transaction, the PCH 10 opens a carrier account with the carrier 20. As part of the process of opening a new account for the PCH 10, the PCH 10 provides sender identification (ID) data 106 such as a username or login ID, and password, to the carrier 20. The carrier 20 stores the sender ID data 106 in association with the carrier account data 108 in database storage unit 204. The carrier account data 108 uniquely identifies the carrier account of PCH 10 from other carrier accounts. The carrier 20 stores a record relating the sender ID data 106 to the carrier account data 108 in its database storage unit 204. In addition, the carrier 20 stores a record relating the carrier account data 108 with procurement card data 111 in the database storage unit 204. The procurement card data 111 uniquely identifies procurement card 50, and may comprise a unique procurement card number assigned by the PCP 30. The procurement card data 111 can also comprise the expiration date of the procurement card. The procurement card data 111 is generally provided to the carrier 20 by the PCH 10 or PCP 30 before commencement of a shipment transaction.

In the process of carrying out a shipment transaction, a sender 110 uses the computer 102 to establish communication with computer 202 of the carrier computer system 200 over a network. The sender 110 can accomplish this task by entering the universal resource locator (URL) into the address field of a browser application 103 executed by the computer 102. In response to entry of the URL, the browser application 103 establishes communication over the network, such as the Internet or World Wide Web (WWW), with the program 116 executing on the computer 202. The computer 102 can interact with an internet service provider (ISP) or other point-of-presence (POP) serving as a gateway to the Internet or WWW. Alternatively, the computer 102 can be connected to a gateway server (not shown) of the PCH 10, which itself acts as a POP or gateway to the Internet or WWW.

The sender 110 inputs sender data 106 using the computer 102. The sender ID data 106 can be a user name or login ID, and a password, for example. The sender ID data 106 uniquely identifies the sender from others that are authorized to ship packages at the PCH entity. The sender 110 can be: (a) an individual, (b) a group or department, and/or (c) a location, site or building, of the PCH entity. For enhancing the ability to track responsibility for shipment charges within the PCH entity, each procurement card uniquely identified by its procurement card data, can be assigned to each individual authorized to ship packages within the PCH entity, by mapping such procurement card data to sender ID data identifying the individual. However, by assigning procurement cards on an individual basis at the PCH entity, the number of procurement cards that must be administered by the PCH entity to track shipment charges, is generally increased. In those instances in which applicable policies, laws, and/or regulations permit, it may be desirable for the PCH entity to track shipment charges for accounting purposes at a higher level, such as a group, department, location, site or building within the PCH entity. The level of specificity for the sender class thus depends upon the accounting and financial management objectives of the PCH entity, and any applicable accounting requirements that may be imposed on such entity.

The sender data 106 can comprise other data regarding the sender, such as the sender's name and address. The sender ID data 106 can be entered into a web page or document, for example, displayed by the computer 102 by execution of the browser application 103. Such data can be input by the sender 110 at the computer 102 through a browser application, for example. The computer 102 transmits the sender ID data over a network to carrier computer system 200. The carrier computer system 200, or more specifically, the computer 202, receives the sender ID data 106 and uses it to locate corresponding carrier account data 108 in the database storage unit 204. The carrier computer 202 further uses the identified carrier account data 108 to reference the database storage unit 204 for the corresponding procurement card data 111. The procurement card data 111 is used by the carrier 20 to obtain payment for shipment of package 40. In addition to the procurement card number and expiration date, the procurement card data 111 can also comprise the network address of the PCP 30 to enable the carrier 20 to transmit data for the shipment transaction to the PCP.

The sender 110 enters shipment data 112 into the computer 102, and transmits same to the carrier computer system 200 over a network. The shipment data 112 can comprise data that identifies certain factors that can impact cost of shipment, such as the weight, dimensions, and contents of the package, the distance over which the package is to be shipped indicated by the sender's and recipient's addresses, and/or the level of service or speed of delivery of the package from sender to recipient, and possibly other factors. The carrier computer system 200, or more specifically the computer 202, receives the shipment data 112 from the computer 102 and generates transaction data 114 based thereon. The transaction data 114 includes cost data 115 indicating the shipment cost charged by the carrier 20 to deliver the package 40. In addition, the transaction data 114 can include other data pertaining to the transaction, such as the date and time of pick up of the package 40 from the sender 110, the date and time of delivery of the package 40 to the recipient 60, the invoice date on which the carrier 20 has invoiced the PCH 10, and other data. The transaction data 114 can be derived from the shipment data 112 by using the shipment data to reference the database storage unit 204 for corresponding transaction data 114. Alternatively, or in addition, the computer 202 can generate the transaction data 114 using the shipment data 112 based on execution of the program 116 in the computer 202. The transaction data 114 can also be generated based on combination of the above techniques, using a portion of the shipment data 112 as a reference for corresponding transaction data 114, and using another portion of the shipment data 112 to generate the transaction data 114.

The sender 110 further inputs reference data 118 using the computer 102. The reference data 118 can be an internal reference of the PCH entity that identifies a sub-category of the cost center to which the shipment cost pertains. For example, the cost center may be “Grant No. AF123-4567-8910—David Layerinomaster, Ph.D., Astronomy Department” and the reference data may be “2200—Research.” The reference data 118 thus can provide virtually any level of specificity of any sub-category(ies) of the cost center that is to be tracked under applicable accounting policies established for that cost center. The sender 110 transmits the reference data 118 from the computer 102 to the carrier computer system 200 over a network. The carrier computer system 200, or more specifically the computer 202, receives the reference data 118. The reference data 118 is not changed by the carrier 20. Instead, the computer 202 transmits the reference data 118 along with the procurement card data 111 and transaction data 114, over a network to the PCP 30, or more specifically, the computer 302 of the PCP computer system 300. To make this possible, the procurement card data 111 can include the network address of the computer 302 as a part thereof. Hence, the carrier computer system 200 can transmit the procurement card data 111, transaction data 114, and reference data 118 to the network address of the computer 302. The computer 302 may itself act as a gateway or point-of-presence on the WWW or Internet to transmit the data 111, 114, and 118 in hypertext mark-up language (HTML) or eXtensible Mark-up Language (XML) to the PCP computer system 300. Alternatively, the computer 202 can transmit such data to the PCP computer system 300 in electronic data interchange (EDI) format over a network to the network address of the computer 302. Other options for transmission of the data 111, 114, 118 are of course possible.

The PCP computer system 300 receives the procurement card data 111, the transaction data 114, and the reference data 118 from the carrier computer system 200. The PCP computer system 300 uses the procurement card data 111 to reference a record stored in the database storage unit 304 that relates the procurement card data 111 to the cost center ID data 121. The computer 302 retrieves the stored cost center ID data 106 from the database storage unit 304. The computer 302 transmits the cost center ID data 121, reference data 118, and transaction data 114 including cost data 115, to computer 104 of PCH computer system 100. For example, the transmission of the cost center ID data 121, reference data 118, and transaction data 114 may be done in the form of an invoice or statement of account. The transmission of cost center ID data 121, reference data 118, and transaction data 114 can be done over a network such as the WWW, Internet, TelNet, TelConnect, or other network using HTML, XML formats using HTTP/IP protocols, facsimile and/or EDI format and protocols, for example.

The computer 104 receives the cost center ID data 121, reference data 118, and transaction data 114 including cost data 115 from the computer 302 of PCP computer system 300. For example, in a “pull” model, the computer 104 can execute a program 119 in the form of a browser application to access and download the cost center ID data 121, reference data 118, and transaction data 114 including cost data 115, from the PCP computer system 300. In a “push” model, the PCP computer system 300 initiates transmission of such data to the computer 104. The computer 104 is used by accountant 120 to apply the cost of shipment of the package 40 to the appropriate cost center 122 and sub-category 123 thereof, using the cost center ID data 121 and the reference data 118, respectively. The cost center 122 can be a particular bank account, grant fund, or other source of funds held by the PCH entity or its bank. The accountant 120 provides payment data 124 to pay the PCP 30 for the package shipment cost using a check, money order, electronic funds transfer (EFT) or other means of payment. The PCP 30 provides payment data 126 to the carrier 20 to cover the cost of shipment of the package 40. The carrier 20 in turn uses a portion of the received funds to cover payment of any sales taxes or customs duties that may be payable for the shipment.

Through use of the cost center ID data 121 and the reference data 118, the PCH 10 is able to properly account for shipment costs incurred. Proper allocation of shipment cost to cost centers of the PCH 10 is generally highly desirable from the standpoint of being able to manage budgets and financial matters of the PCH 10. Moreover, the proper allocation of shipment cost can also be mandated by government rules or regulations, as is often the case if the PCH 10 is an entity such as a university, college, or other government-funded entity, for example. The ability to relate the sender ID data 106 to the cost center ID data 121 affords a desired degree of tracking of responsibility for incurring shipment costs at the PCH 10 that can be as general as the department, building, or location level down to the individual level. Visibility from an accounting standpoint as to what entities within the PCH 10 are incurring shipment costs can be as specific or as general as desired. Moreover, further shipment cost tracking accountability is added through use of the reference data 118 which propagates in a round trip from sender 110 of the PCH 10, to the carrier 20, to the PCP 30, and back to the accountant 120 of the PCH 10. The reference data 118 affords an extra degree of granularity in accountability to a sub-category of the cost center 122 that is to be charged the shipment cost. The reference data 118 is also indicated by the sender 110, a person who may have the greatest understanding of the subcategory of cost center to which the shipment cost is to be applied. Accordingly, the systems, methods, and articles of the invention embodied in FIG. 1 are believed to afford several advantages over previous techniques for accounting for shipment costs to apply them to appropriate cost centers.

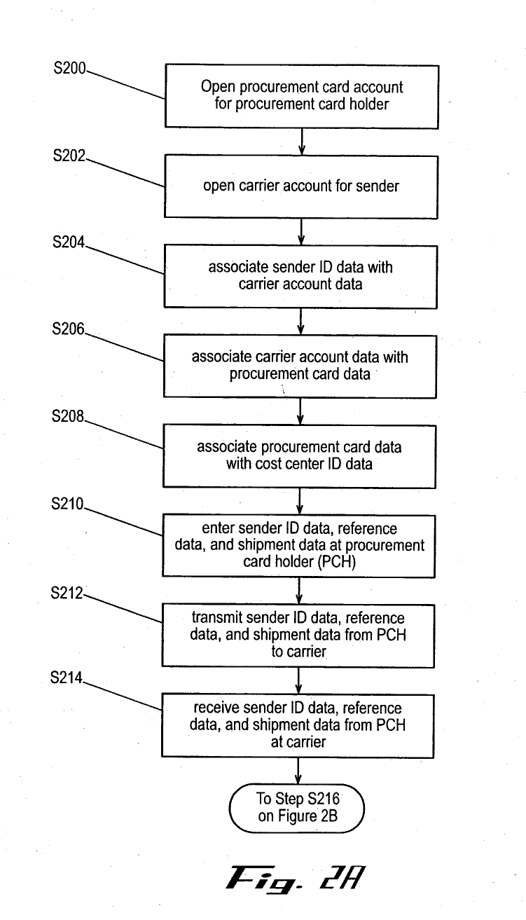

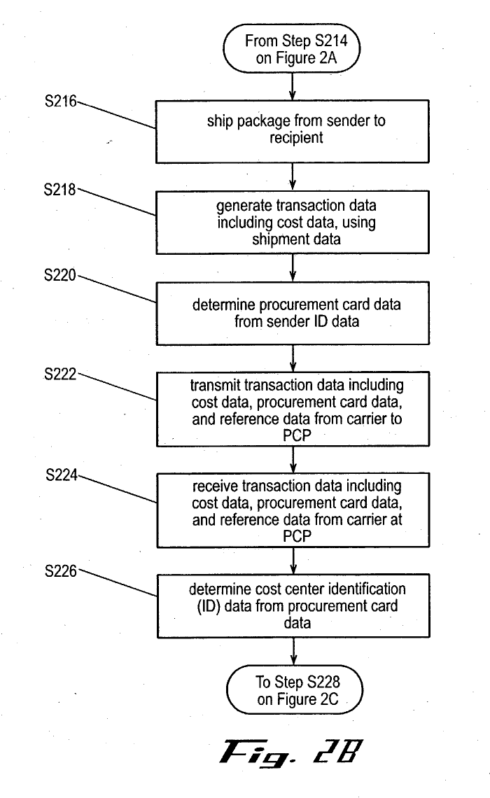

The method of FIG. 2 begins in step S200 in which a procurement card account is opened by PCH 10 with PCP 30 by submission of an appropriate application. Upon acceptance of the application, the PCP 30 assigns a unique procurement card number designating the opened account, and optionally an expiration date, which are related to a cost center identified by the PCH 10 on the submitted application. The PCP 30 stores data indicating the procurement card number and optionally the expiration date of the procurement card 50, as procurement data 111 in the database storage unit 304. In addition, the PCP 30 stores cost center ID data 121 in association with the procurement data 111. The PCP 30 further issues the procurement card 50 to the PCH 10. Note that the PCH 10 need not make the procurement card 50 generally available to persons within the PCH 10 for purposes of shipping packages, because the procurement card number is not required by the sender 110 to ship a package. Because the procurement card 50 is not generally available to persons within the PCH entity, the opportunity for abuse of the procurement card 50 by incurring unauthorized charges is relatively limited. In step S202, the PCH 10 opens a carrier account with the carrier 20. Upon acceptance of an application to open the carrier account, a unique alphanumeric string is assigned as carrier account data 108 to identify and distinguish the newly opened carrier account from other accounts. In step S206, sender ID data 106 provided by sender 110 at PCH 10 is associated with the carrier account data 108. In step S206, the carrier 20 stores the sender ID data 106 in correspondence with the carrier account data 108 as a record in the database storage unit 204. In step S208, the carrier 20 associates carrier account data 108 with procurement card data 111. The procurement card data 111 can be supplied by PCH 10 or PCP 30 under permission from PCH 10. The carrier account data 108 and associated procurement card data 111 can be stored as a record in the database storage unit 204. After performance of steps S200 through S208, the computer systems 100, 200, 300 of the PCH 10, the carrier 20, and the PCP 30, are prepared to allocate shipment costs incurred by the sender 110 to the appropriate cost center 122 and sub-category 123 thereof.

To begin a shipment transaction, in step S210, the sender 110 enters sender ID data 106, reference data 118, and shipment data 112 at computer 102 of the PCH 10. In step S212, the sender 110 transmits a sender ID data 106, reference data 118, and shipment data 112 from the PCH 10 to the carrier 20. In step S214, the carrier 20 receives the sender ID data 106, reference data 118, and shipment data 112 from the PCH 10. In step S216, the carrier 20 picks up the package 40 from the sender 110 at the PCH 10, and transports such package to the recipient 60 using the recipient address provided by the sender 110 in the shipment data 112. In step S218, the carrier computer system 200 generates transaction data 114 which includes cost data 115 indicating the cost of the shipment to be charged by the carrier 20 to the PCH 10 through the PCP 30. The transaction data 114 is generated based on the shipment data 112 from the sender 110. For example, the cost data 115 may be generated based on one or more factors, including the sender address, the recipient address, the weight or dimension of the package, and the level of service or speed of delivery requested by the sender. The carrier computer system 200 also determines procurement card data 111 using the sender ID data 106. As shown in FIG. 1, this can be done by mapping the sender ID data 106 to carrier account data 108, which in turn is mapped to procurement card data 111. In step S222, the carrier computer system 200 transmits transaction data 114 including cost data 115, procurement card data 111, and reference data 118, from the carrier 20 to the PCP 30. In step S224, the PCP 30 receives the transaction data 114 including the cost data 115, the procurement card data 111, and the reference data 118, from the carrier. In step S226, the PCP computer system 300 determines cost center ID data 121 using procurement card data 111. In step S228, the PCP 30 transmits transaction data 114 including cost data 115, cost center ID data 121, and reference data 118, to the computer 104 of the PCH 10. Because the transaction data 114 is provided to the PCH 10 along with the cost center ID data 121 and reference data 118 necessary to identify the cost center and subcategory thereof to be charged for the shipment cost, the PCH 10 is able to pay the carrier 20 through the PCP 30 for the shipment cost from the relevant cost center and sub-category within the cost center. This enables a relatively high degree of visibility and accountability for shipment costs incurred by the PCH 10. It also assists the PCH 10 to keep accounting records suitable for audit by relevant authority.

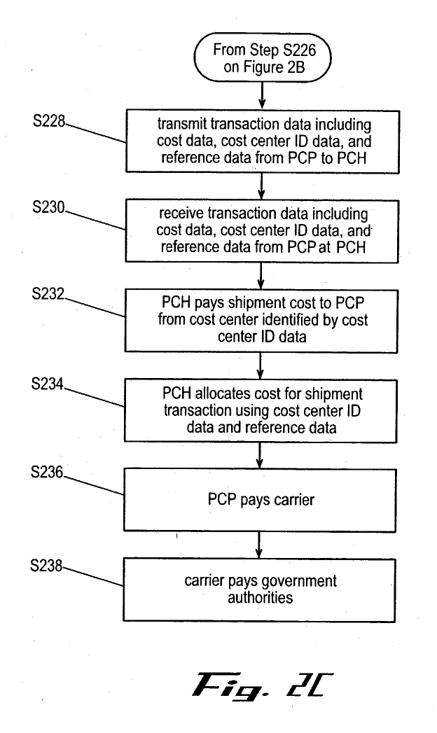

In FIG. 3, a more specific embodiment of the systems and methods of the preferred embodiment of the invention, is shown. As previously described, the participants in a shipment transaction are the PCH 10, the carrier 20, the PCP 30, and recipient 60. In addition, third party data processor 70 is employed to interface the PCP 30 and the PCH 10.

At the PCH 10, sender 110 desires to ship package 40 to the recipient 60. The sender 110 uses computer system 102 of the PCH 10 in order to establish communication with the carrier's computer system 200. For example, sender 110 can use computer 102 running a browser client application to interact with a program executed by server 202 of carrier's computer system 200. The sender computer 102 can communicate with the carrier computer 202 through gateway server 128 of the PCH computer system 100 over public network 134, which may be the World Wide Web (WWW) or Internet, for example. Communication between the computer 102 and server 202 can be in accordance with protocol layers defined in the International Standards Organization/Open Systems Interconnection (ISO/OSI) reference model and defined in Institute of Electronics and Electrical Engineers (IEEE) standard 802.xx. The browser application executed by computer 102 can be used to access a server application executed by the computer 202. For example, using the address field in the browser application to address https://www.upscampusship.com, a package shipment application provided by United Parcel Service®, Inc. can be accessed by the sender 110. Using the browser interface, the sender 110 enters the sender ID data 106, shipment data 112, and reference data 118 into the computer 102. The sender ID data 106 can include a username or login ID, and a password, for example. The shipment data 112 indicates data necessary or desirable in shipping the package, and may comprise the recipient's name and address, weight, dimensions, and/or level of service or speed for delivery of the package, the sender's name and address, etc. The reference data 118 indicates a sub-category of the cost center 122 to which the shipment cost is to be applied. It is preferred that the server application executed by the carrier computer 202 be such as to require the sender 110 to enter at least the sender ID data 106, reference data 118, and any necessary shipment data 112, to ensure that sufficient information is captured to be able to ship the package and to permit the PCH 10 to allocate the shipment cost to the appropriate cost center 122 and sub-category 123 thereof. The sender 110 operates computer the 102 to transmit such data to computer system 200 via gateway server 128 over the network 134.

The carrier computer system 200, or more specifically, the computer 202, receives the sender ID data 106, the shipment data 112, and the reference data 118. The computer 202 can store this data in its own memory, or may store the data in database storage unit 204. The carrier 20 can use the sender ID data 106 to retrieve carrier account data 108. In the process of opening a carrier account, the sender has previously identified its username or login ID and password, which the carrier 20 stored in the database storage unit 204 in association with the carrier account data 108 including a unique alphanumeric string so that shipment activity of the sender can be appropriately tracked and billed. The computer 102 also uses the carrier account data 108 to obtain procurement card data 111. The procurement card data 111 identifies a procurement card number and expiration date. The procurement card data 111 can also identify a network address of the PCP 30 so that the carrier 20 can communicate with the PCH computer system 30.

The computer 202 generates tracking number data for the shipment transaction underway. The tracking number data uniquely identifies the package shipment, and as its name suggests, permits the package shipment to be tracked so that its status in transit from sender 110 to recipient is available to the PCH 10, carrier 20, and recipient 60. The computer 202 uses at least the tracking number data and data indicating the recipient name and address, and optionally also the name and address of the sender 110, to generate a shipment label 136. The computer 202 can encode the tracking number data, recipient name and address, optionally the sender name and address, in a bar code, radio-frequency identification (RFID) tag, or other scannable indicia provided in the shipment label 136. The computer 202 transmits the shipment label 136 in signal form, e.g., a web page document, to the sender's computer 102 via network 134 and gateway server 128. The sender's computer 102 receives and displays the shipment label 136 to the sender 110. The sender 110 operates the computer 102 to print the shipment label 136 using printer 130. The sender 110 affixes the printed label 136 to the package 40 for shipment to the recipient 60. The sender 110 then provides the package 40 to the carrier 20 for shipment to the recipient. The sender 110 can do so by leaving the package at an established drop off location of the PCH 10 or elsewhere, providing the package to a driver 138, or scheduling a pickup via carrier computer system 202 via carrier dispatch network 206. The driver 138 receives the package 40 and scans the shipment label 136 with a scanning device 140 such as an optical laser scanner or RF reader. The scanning device 140 transmits the scanned data including the tracking number data and pickup time and date time to carrier computer system 200 via carrier network 206. The computer system 200 receives the tracking number data and pickup time and date, and stores same in database storage unit 204 in association with the carrier account data 108 as transaction data 114 pertaining to the shipment transaction underway. Carrier transport network 208 including one or more delivery vehicles, trucks, trains, and/or aircraft, transports the package 40 to the recipient 60. At delivery of package 40 to recipient 60, driver 146 scans the shipment label 136 with scanning device 142, which transmits data indicating the tracking number and delivery time and date, to the computer 202 of the carrier computer system 200 via the network 206. The computer 202 uses the shipment data 112 to generate transaction data 114. The transaction data 114 includes cost data 115 that indicates the amount due from the sender 110 for shipment of the package to the recipient 60. The cost data 115 can be generated by the computer 202 and/or records stored in the database storage unit 204 based on established rates for the transport distance from sender to recipient as indicated by their addresses, weight, dimensions, contents, level of service, insurance on package contents, taxes, customs duties, and/or other factors.

As previously mentioned, the computer 202 uses the sender ID data 106 to retrieve carrier account data 108 from the database storage unit 204. In addition, the computer 202 uses the carrier account data 108 to retrieve procurement card data III from the database storage unit 204. The procurement card data 111 indicates the procurement card account of the PCH 10 to which the cost of shipment indicated by data 115, is to be charged. The procurement card data 111 can also indicate a network address of the computer 302 of the PCP computer system 300 to which the computer 202 is to send certain data. More specifically, the computer 202 transmits transaction data 114 including cost data 15, procurement card data 111, and reference data 118, to the computer 302 of the PCP computer system 300 using the network 308, which may be a public network such as the Internet, WWW, facsimile, TelNet, and/or wireless network, for example.

The PCP 30, or more specifically the computer 302 of the PCP computer system 300, receives the transaction data 114, the procurement card data 111, and the reference data 118, from the computer 202 of the carrier computer system 200. The computer 302 transmits the cost center ID data 106, reference data 118, and transaction data including cost data 115, over a network 310. The computer 302 can transmit such data in the form of an electronic or “soft” invoice or statement of account. Before transmission, this data can be accumulated by the PCP 30 with other data for one or more other transactions pertaining to PCH 10. This data can be accumulated over a period of time such as one week, for example. In any event, whether for one or more transactions, the computer 302 transmits the transaction data 114, the procurement card data 111, and the reference data 118 over network 310 to computer 702 of the third party data processor 70.

The computer 702 receives such data and uses the procurement card data 111 to reference the database storage unit 704 to retrieve cost center ID data 121. Hence, note in this particular embodiment of the invention, rather than storing the relationship between the procurement card data 111 and the cost center ID data 121 at the PCP 30, the relationship between this data is instead stored in third party data processor 30. The third party data processor 30 can generate a listing of one or more transactions for the PCH 10 including the cost center ID data 121, the reference data 118, and pertinent transaction data 114 including cost data 115. The third party data processor 70 can make the listing of transaction data 114 available to accountant 120 using computer 104 of PCH 10 in a variety of ways. For example, in a “pull” mode of operation, accountant 120 can enter a URL of the website corresponding to third party data processor 70 into a web browser application executing on computer 104 of the PCH 10. The computer 104 of the PCH 10 communicates with computer 702 of the third party data processor 70 via gateway server 144 over network 311, which in this case is the Internet or WWW, signaling a request for a web page identified by the URL. After requesting a username or login ID and password from the accountant 120 and verifying that such person is authorized to access data by pre-established authorization from the PCH 10, the computer 702 generates a web page including corresponding transaction data 114, cost center ID data 121, and reference data 118. The computer 702 of the third party data processor 70 transmits such web page to the accountant's computer 104 via network 311 and gateway server 144 for display thereon. In a “push” mode, the third party data processor 70 can transmit corresponding transaction data 114, cost center ID data 121, and reference data 118 to the computer 104 via network 311 and gateway server 144 without receiving a request to access such data from the accountant 120. In this case, the data can be stored by server 144 or computer 104 for access by accountant 120 when desired.

The accountant 120 draws a payment from the cost center 122 of the PCH 10 that is identified by the cost center ID data 121, to cover the shipment cost(s) indicated by the cost data 115, and transmits such payment data to the PCP 30. The accountant 120 allocates the payment data 124 from the cost center 122 and subcategory 123 thereof, so that the shipment cost can be allocated to the cost center and subcategory with sufficient specificity to produce an auditable record for a desired degree of accountability. The payment data 124 can be made by the PCH 10 using check, money order, draft, EFT, or any other means for transmitting funds between entities. In FIG. 3, the accountant 120 can use the computer 104 to print a check using printer 146 to mail to the PCP 30. Alternatively, the PCH 10 can use EFT to transmit payment data 124 in electronic or “soft” form to the computer 302 of PCP 30. The PCP 30 causes a funds transfer of the payment data 124 from the PCH bank 80 to PCP bank 85. This can be done by EFT initiated by the computer 302 over EFT network 312 or by transfer of printed check or other instrument. The PCP 30 instructs its bank 85 to transfer funds to carrier's bank account through pre-established data or transaction data 114 received from the carrier computer system 200. The carrier computer system 200 then authorizes its bank 90 to transfer EFT funds from its account to an account at government bank(s) 95 to cover costs for any sales taxes and customs duties. The transfer of funds between carrier 20, PCP 30, PCH bank 80, PCP bank 85, carrier's bank 90, and government bank 95 can be performed in electronic or “soft” signal form, or alternatively, may be affected by checks, money orders, cash, or other instruments.

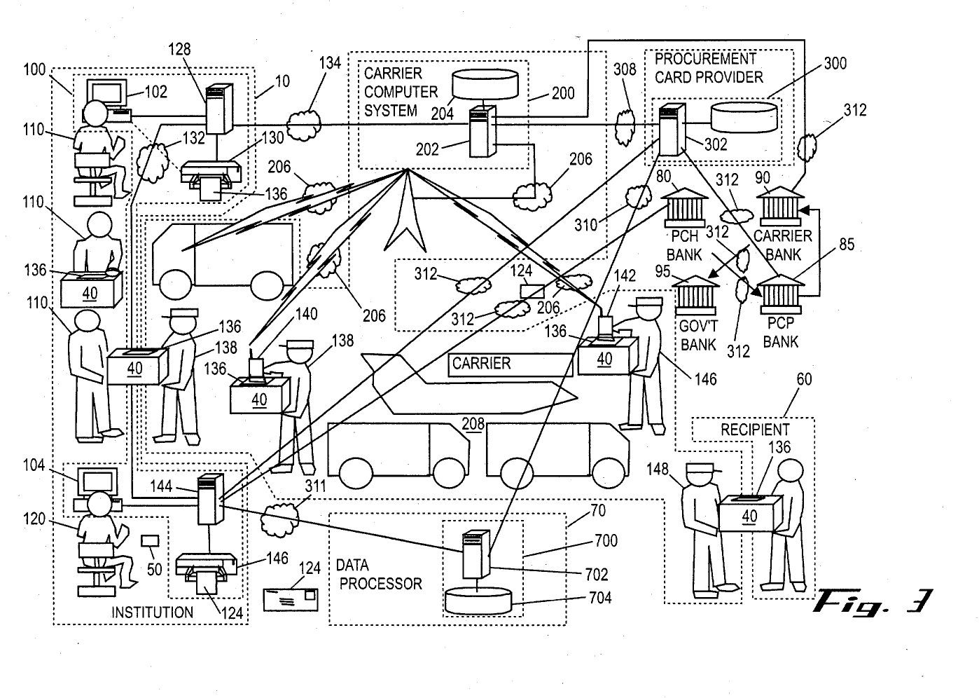

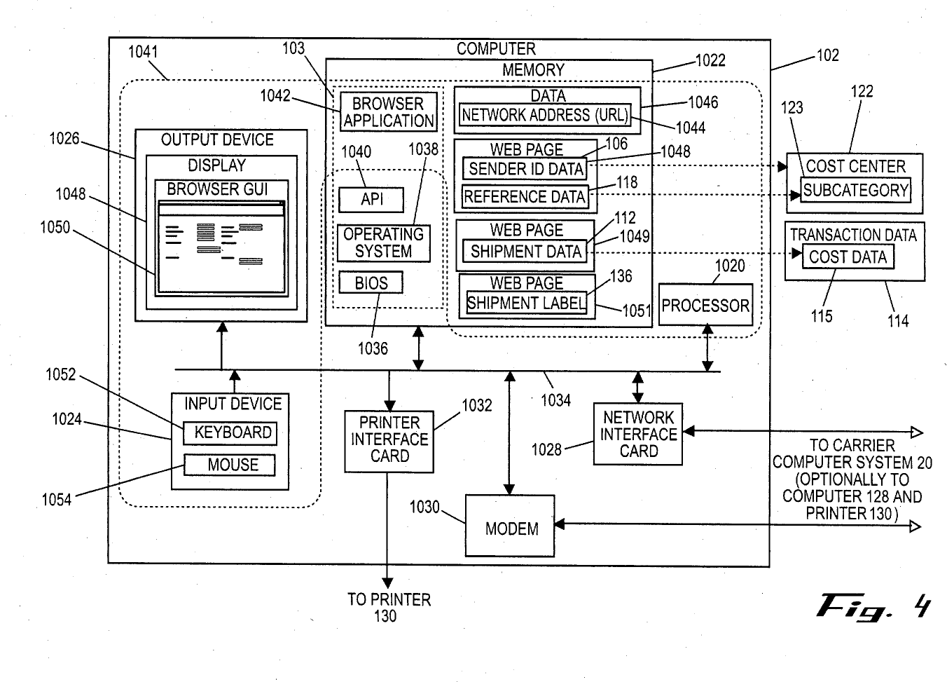

In FIG. 4, the computer 102 of the PCH 10 is shown in relative detail. The computer 102 comprises processor 1020, memory 1022, input device 1024, and output device 1026, network interface card (NIC) 1028, modem 1030, printer interface card (PIC) 1032, connected via bus 1034. Upon initial power up of the computer 102, the processor 1020 retrieves the binary input/output system (BIOS) 1036 from the memory 1022. It should be understood that the memory 1022 can and normally comprises several different data storage devices, including normal memory a read-only memory (ROM), random-access memory (RAM), and a hard-disk drive or storage unit. The processor 1020 reads the BIOS 1036 from non-volatile ROM and executes the BIOS to retrieve the operating system 1038 from the hard drive of the memory 1022. The processor 1020 stores the operating system 1038 in the RAM of memory 1022 where it can be executed by the processor 1020 to communicate with the hard drive of the memory 1022, the input device 1024, the output device 1026, NIC 1028, modem 1030, and PIC 1032 via the bus 1034. The sender 110 can operate graphical user interface (GUI) 1041 to launch the browser application 1042. The GUI 1041 comprises input device 1024, output device 1026, the browser application 1042, web page documents 1048, and possibly also data 1046 stored in the memory 1022, which are used by the processor 1020 to generate the display 1048 on the output device 1026. The display 1048 includes a browser GUI display 1050. The sender 110 can use the input device 1024, e.g., keyboard 1052 and/or mouse 1054 to input a network address 1044 into a field defined in browser GUI 1050. the processor 1020 executes the browser application 1042 to communicate with a server application executed by the carrier computer system 200 via NIC 1028 and/or modem 1030. In response to entry of the network address or URL 1044, the carrier computer system 200 executes the server application to retrieve a web page document and transmits the same to the processor 1020 via the NIC 1028 or modem 1030. The processor 1020 stores the web page document in the memory 1022 and executes its script to generate browser GUI 1050 displayed by the output device 1026. Browser GUI 1050 prompts the user to input sender ID data 106. Using the input device 1024, the sender 110 enters the sender ID data 106, e.g., login ID or user name, and password, into the field of the browser GUI 1050. The processor 1020 transmits the sender ID data 106 to the carrier computer system 200. As previously described, the sender ID data 106 is, through a series of data relations, associated with the cost center 122 to which the cost of the shipment of the package 40 is to be charged. In response to receiving the sender ID data 106, the carrier computer system 200 checks the data to ensure that the sender 110 is authorized to transmit packages. If the carrier computer system 200 determines that the sender 110 is not authorized to transmit the packages, the carrier computer system 200 transmits a web page document to the computer 102 which is executed by the processor 1020 producing a message to the sender 110 indicating that the package shipment is not authorized. On the other hand, alternatively, if package shipment is authorized, the carrier computer system 200 transmits a web page document prompting the user to enter reference data and shipment data. The processor 1020 receives this document via NIC 1028 or modem 1030, and executes such web page document to generate a display 1048 with browser GUI 1050 prompting the user to enter such data. The sender 110 operates the input device 1024 to input the reference data 118 and the shipment data 112 using the GUI 1041. As previously mentioned, the reference data 118 it is ultimately used to identify the subcategory 122 of the cost center 123 through a series of data relationships stored in the carrier computer system 200. The shipment data 112 specifies various parameters used by the carrier computer system 200 to compute the cost of the shipment. The cost of the shipment is indicated by cost data 115 of transaction data 114. The processor 1020 sends the web page document including the reference data 118 and the shipment data 112 to the carrier system 200 via bus 1034 and NIC 1028 or modem 1030. The carrier computer system 200 thus receives the shipment data 112 to determine cost data 115 in the shipment transaction. It also receives the reference data 118 for transmission along with the transaction data 114 to the PCP 30 and ultimately back to the PCH 10 so that the shipment cost can be allocated to the appropriate sub category 123 of the cost center 122. The carrier computer system 200 also uses the shipment data 112 to generate the label via 136. The carrier computer system 200 can include a unique tracking number and other data in the shipment label 136 so that progress of the package 40 when shipped from PCH 10 to recipient 60, can be tracked, monitored, and used to confirm pick up and delivery of the package 40. The carrier computer system 20 transmits the shipment label 136 to the computer 102. The processor 1020 receives the shipment web page document 1048 including the shipment label 136 and displays same on the browser GUI 1050 of the output device 1026. The sender 110 operates the input device 1024 to cause the processor 1020 to execute the program 103 to transmit a print data stream to the printer 146 via printer interface card 1032. The shipping label 136 is printed by the printer 146 to produce a hard copy that the sender 110 attaches to the package 40 in preparation for shipment.

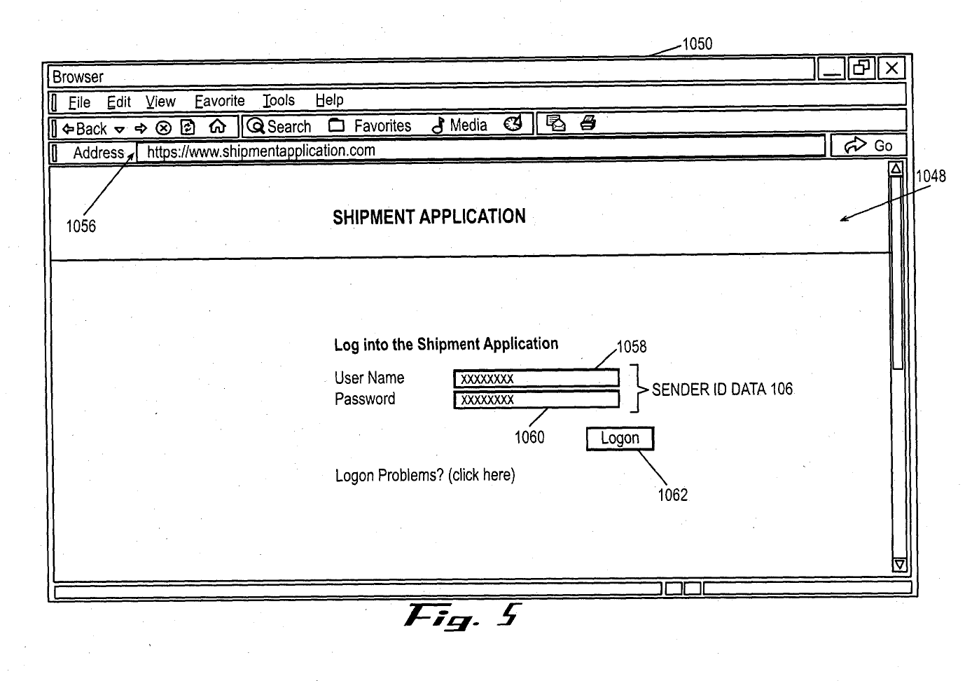

In FIG. 5, the GUI browser 1050 generated on the computer 102, is shown. The GUI browser 1050 comprises fields 1058, 1060 labeled “User Name” and “Password,” respectively, which prompt the sender 110 to enter corresponding data as the sender ID data 106. Upon pressing soft button 1062 with a cursor controlled by the mouse 1054 of the input device 1024, the web page document 1048 is posted to the carrier computer system 200 where the sender 110 can be verified as authorized to use shipment services offered by the carrier 20. This can be accomplished by checking the sender ID data against an authorization list stored by the carrier computer system 200. Furthermore, the sender ID data 106 is used by the carrier computer system 200 to determine carrier account data 108 that corresponds to the sender 110. This enables the carrier to track shipment transactions for the sender 110 by carrier account. The sender ID data 106 is further used to identify the procurement card account of the PCH 10 to which the carrier 20 is to charge the cost of shipment of the package, as previously described.

In FIG. 6, the GUI browser 1050 generated by the computer 102 of the PCH 10, is shown. In FIG. 6, the web page document 1049 has data entry fields to prompt the user to enter the shipment data 112, and the reference data 118. The shipment data 112 comprises recipient data 113 identifying the name and address of the recipient, and package data 115 indicating characteristics of the package to be shipped. As shown in FIG. 6, the recipient data 113 comprises at least the address of the recipient, which includes the street or post office address, city, state, postal code, country, and possibly other information that may be required to identify the address of the recipient. In addition, the recipient data 112 can also comprise the recipient's name, an indication that the package is to be shipped to the attention of a particular person at the recipient, the recipient's address, city, state, postal code, country, telephone number and extension, email address, nickname, and an indication as to whether the address is a residence address. At the bottom of the web page document 1049, “ship from” data appears. This data is incorporated into the web page document 1049 by the server application executed by the carrier computer system 200. The carrier computer system 200 is able to determine the name and address of sender 110 using the sender ID data 106 provided by the sender 110 upon posting the web page document 1048 to the server application of the carrier computer system 200. The sender 110 can also use the input device 1024 and output device 1026 of the computer 102, to enter package data 115 in corresponding data entry fields. The package data 115 can indicate the weight of the package, the type of package shipped, the level of service, whether return service is to be available, and the dimensions of the package 40. Importantly, the web page 1049 also comprises a field in this example titled “fund account” which prompts the user to enter reference data 118 in the corresponding data entry field 1068. It is possible that the web page 1049 can be provided with a select soft button 1070 permitting the sender 110 to select reference data entered in a previous shipment transaction and stored at the carrier computer system 200. As previously described, the reference data 118 identifies a subcategory 123 of the cost center 122 to which the cost of the shipment is to be applied by the PCH 10 for its accounting and management purposes. When the sender 110 has entered the shipment data 112 and reference data 118 into the web page form, the sender 110 operates the computer 102 to activate the “ship package” soft button 1064. This causes the browser application 1042 executed by the processor 102 to transmit the shipment data 112 and the reference data 118 to the carrier computer system 200. The fields with asterisks shown in FIG. 6 indicate data that is mandatory for the sender 110 to enter before the server application executed by the carrier computer system 200 will accept the data, and hence the shipment transaction. Thus, the sender 110 is in effect forced to enter the reference data 118 identifying the appropriate subcategory 123 of the cost center 122 to which the shipment charge is to be applied, before the shipment transaction will be undertaken by the carrier computer system 200. Thus, it is relatively assured that the PCH 10 can charge the shipment cost to the appropriate subcategory 123 of the cost center 122.

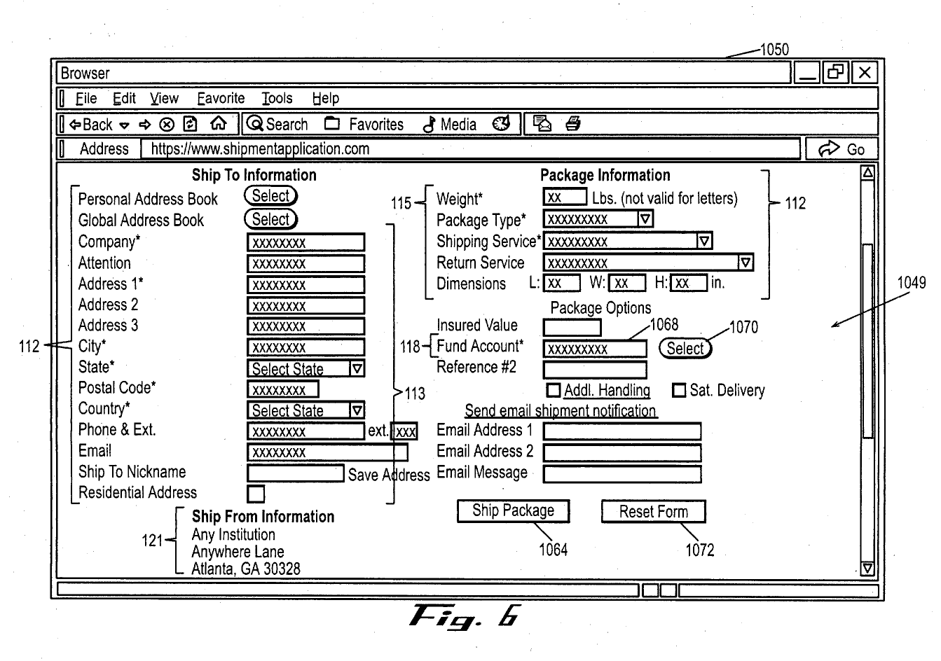

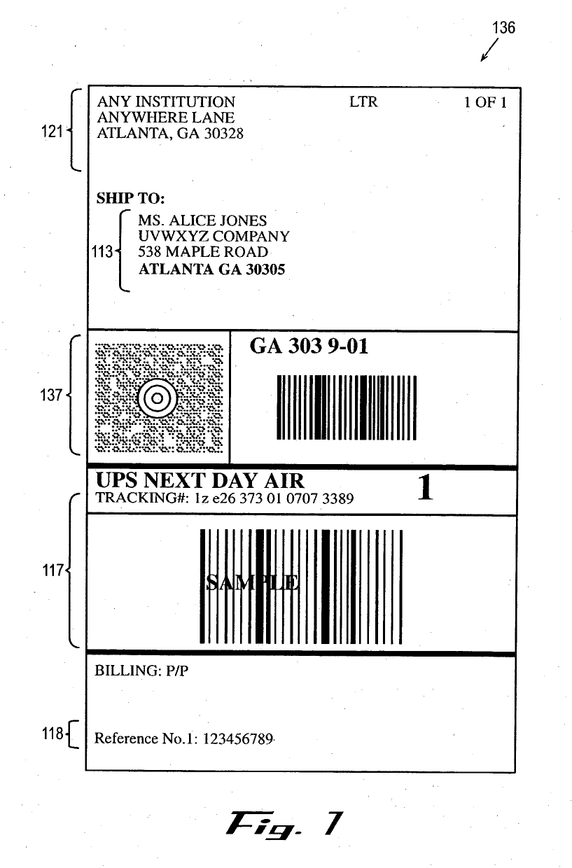

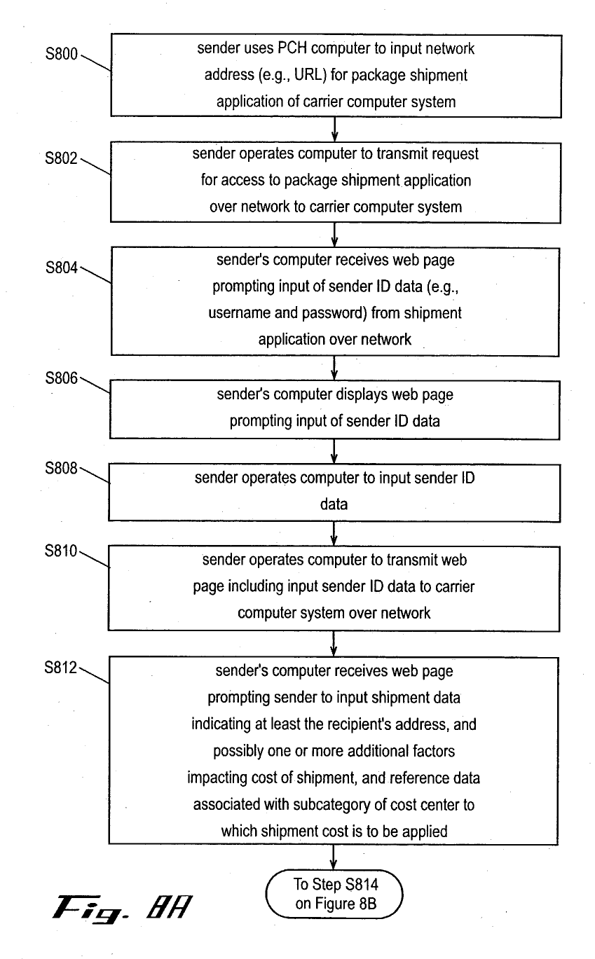

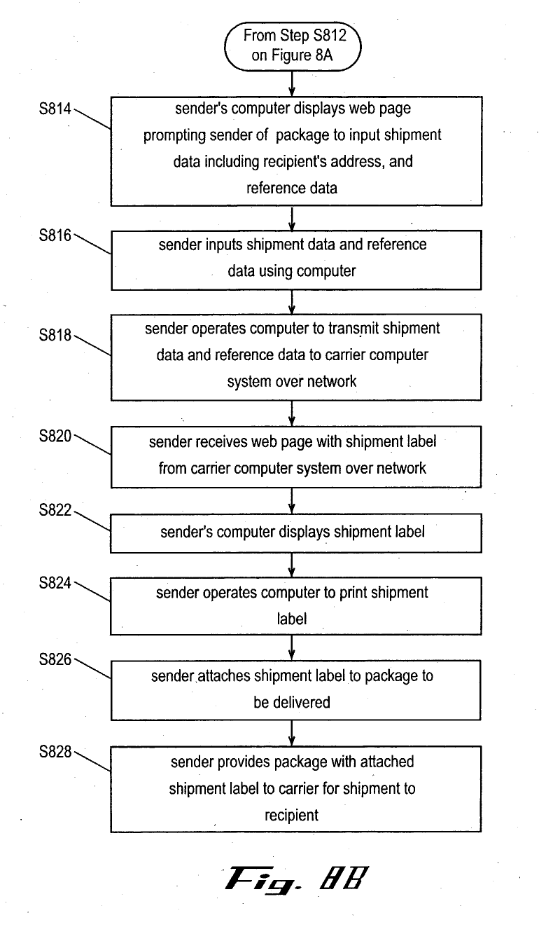

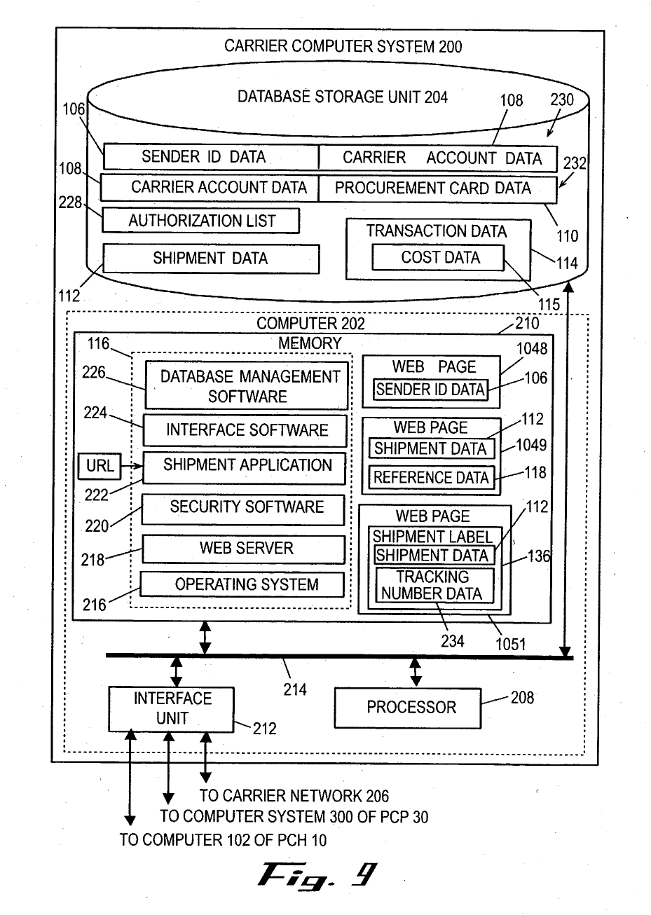

In FIG. 7, a shipment label 136 is shown. The shipment label 136 has indicia including the printed recipient data 113 indicating the name and address of the package recipient 60. The shipment label 136 further has printed tracking number data 117 which is a unique alphanumeric string assigned to the package 60. The tracking number data 117 can be provided in bar code form to permit it to be scanned by the optical scanning device 140. Such scanning devices are well-known and commercially available from numerous vendors, including Symbol Technologies, Inc., New York, USA. The sender data 121 identifies the name and address of the sender 110. Finally, the reference data 118 can be printed on the shipment label 136. This provides the sender 110 with the option to forward a copy of the shipment label 136 to the accounting department of the PCH 10 for notification that the shipment charge has been incurred before notification by virtue of receiving an invoice for the shipment cost from the PCP 30.

FIGS. 8A and 8B show a method implemented by the sender 110 and the computer 102 to ship a package in a manner that permits tracking of the shipment cost for application to an appropriate cost center and subcategory thereof, of the PCH 10. In Step S800, the sender uses the PCH computer 102 to input the network address (e.g., URL) for a package shipment application of the carrier computer system 200. In step S802, the sender 110 operates the computer 102 to transmit a request for access to the package shipment application to the carrier computer system 200 over the network 134. In step S804, the sender's computer 102 receives the web page 1048 prompting the sender 110 to input sender ID data 106 (e.g., user name and password) from the package shipment application the carrier computer system 200 over the network 134. In step S806, the sender's computer 102 displays the web page 1048 prompting the sender 110 to input sender ID data 106. In step S808, the sender 110 operates the computer 102 to input the sender ID data 106 into the displayed web page. In step S810, the sender 110 operates the computer 102 to transmit the web page including the input sender ID data 106 to the carrier computer system 200 over the network 134. In step S812, the sender's computer 102 receives the web page 1049 prompting the sender 100 to input the shipment data 106 indicating at least the recipient's address, and possibly other factors impacting cost of shipment, and the reference data 118 associated with the subcategory 123 of the cost center 122 to which the shipment cost is to be applied. In step S814 of FIG. 8B, the sender's computer 102 displays the web page 1049 prompting the sender of the package to input shipment data including the recipient's address, and reference data identifying the subcategory 123 of the cost center 122. In step S816, the sender 110 inputs the shipment data 112 including the recipient's address and the reference data 118 using the computer 102. In step S818, the sender 110 operates the computer 102 to transmit the shipment data 112 including the recipient's address and the reference data 118, to the carrier computer system 200 over the network 134. In step S820, the sender 110 receives a web page 1051 with the shipment label 136. In step S822, the sender's computer 102 displays the shipment label 136. In step S824, the sender 110 operates the computer 102 to print the shipment label 136 via the computer 102. In step S826, the sender 110 attaches the shipment label 136 to the package 40 to be delivered to the recipient 60. In step S828, the sender 110 provides the package 40 with the attached shipment label 136 to the carrier 20 for transport to the recipient 60.

In FIG. 9, the carrier computer system 200 is shown schematically in relative detail. The carrier computer system 200 comprises the computer 202 and the database storage unit 204. The computer 202 comprises processor 208, memory 210, interface unit 214, connected via bus 214. The memory 210 stores operating system 216, web server 218, security software 220, shipment application 222, interface software 224, and database management software 226. The processor 208 executes the operating system 216 to enable it to communicate with the database storage unit 204 and the interface unit 212 via the bus 214. The processor 208 executes the web server 218 to communicate with the computer 102 of the PCH 10, using HTTP and TCP/IP protocols. The processor 208 executes the security software 220 which can comprise a firewall to ensure that unauthorized persons cannot access the carrier computer system 200 via the network 134. The security software 220 may also comprise encryption/decryption software used to encrypt and decrypt communications transmitted to the computer 102 of the PCH 10 and the computer 302 of the PCP 30, over respective networks 134, 308 (which may both be the World Wide Web or Internet). The processor 208 executes the shipment application 222 and operating system 216 to interact with the computer 102 of the PCH 10 and the computer 302 of the PCP 30, to perform a shipment transaction in accordance with the invention. The processor 208 executes the interface software 224 to link the shipment application 222 to the operating system 216 so that the processor 208 can interact with the interface unit 212 and the database storage unit 204 in executing the shipment application 222. The processor 208 executes the database management software 226 to access or read, or store, modify, or delete data stored in the database storage unit 204.

As previously described, the database storage unit 204 stores sender ID data 106 in association with the carrier account data 108. Further, the database storage unit 204 stores carrier account data 108 in association with procurement card data 110. These data relationships stored in the database storage unit 204 in effect link the sender 110 to a particular procurement card 50 so that shipment charges incurred by the sender can be appropriately applied to a cost center for that procurement card.

In operation, the processor 208 receives a request from the computer 102 to access the shipment application 222 as indicated by a corresponding URL. The URL in effect gives a file name and path for the processor 208 so that the processor can locate and launch the shipment application 222 from the information given by the URL. Thus, the processor 208 uses URL to retrieve the shipment application 222, and launches such application. The processor 208 also uses the interface software 224 to link the shipment application 222 to the operating system 216. The processor 208 further executes the shipment application 222 to serve web page 1048 including a prompt for the sender 110 to enter sender ID data 106, to the computer 102 of the PCH 10 via the interface unit 212 and the network 134. If the sender 110 posts the web page 1048 back to the computer 202 via the interface 212 and the network 136, and includes sender ID data 106 in such web page, the processor 208 determines from authorization list 228 whether the sender 110 is authorized to access the shipment application to perform a shipment transaction using the sender ID data 106. If the processor 208 determines that the sender 110 is not authorized to the use the shipment application 222, the processor 208 transmits a message to the computer 102 of the PCH 10 via the interface unit 212 and the network 136 to inform the sender of the fact that such entity is not authorized to use the shipment application. Conversely, if the processor 208 determines that the sender 110 is authorized to use the shipment application 222 using the authorization list 228, the processor 208 uses the sender ID data 106 to reference the database storage unit 204. The processor 208 determines that the sender ID data 106 is related to carrier account data 108 using database record 230. Further, the processor 208 uses the carrier account data 106 to reference the database storage unit 204 and thus determines that the procurement card data 110 is related to the carrier account data 108. The processor 208 is thus able to use the series of data relationships stored in the database storage unit 204 to determine that the sender ID data 106 is related to the procurement card data 232. The processor 208 next serves web page 1049 to prompt the user to enter shipment data and reference data. The processor 208 transmits the web page 1049 to the computer 102 of the PCH 10 via the bus 214, the interface unit 212, and the network 134. The processor 208 receives the web page 1049 page including the shipment data 112 and the reference data 118, from the computer 102 via the network 134, interface unit 212, and bus 214. The processor 208 stores the shipment data 112 and the reference data 118 of the web page 1049 in its memory 210. The processor 208 continues to execute the shipment application 222 to determine whether the shipment data 112 is correct in form. If the processor 208 determines that the shipment date is incorrect in its form or that data is missing or incorrect, the processor 208 retransmits the web page 1049 to the computer 1020 via the bus 214, interface unit 212, and network 136, to inform the sender 110 that the shipment date is not in the correct form. Conversely, if the processor 208 determines that the shipment data 112 and the reference data 118 are correct in form, the processor 208 continues to execute the shipment application 222 to generate the shipment label 136. The shipment label 136 includes at least a portion of the shipment data 112, specifically, the recipient's address, and may include other data such as the recipient's name, the sender's name and address, and possibly other data. In addition, the processor 208 generates data 234 indicating a unique tracking number for purposes of tracking pickup, transport, and delivery of the package 40. The processor 208 incorporates the shipment data 112 and tracking number data 234 into the shipment label 136. The shipment label 136 is in turn incorporated in the web page 1051 by the processor 208. The processor 208 further executes the shipment application 222 to transmit the web page 1051 to the PCH computer 102 operated by the sender 110, via bus 214, interface unit 212, and network 134. Upon delivery of the package 40 to the recipient 60, the processor 208 receives a signal or data from the carrier network 206 indicating that the package has been delivered to the recipient 60. The processor 208 can be advised of the delivery of the package 40 to the recipient 60 via the scanning device 142 transmitting a signal to such Processor via the carrier 206, the interface unit 212, and the bus 214. In response to receiving the signal indicating package delivery has been completed, the processor 208 uses the shipment data 112 to generate transaction data 114. A component of the transaction data 114 includes cost data 115 indicating the cost of the shipment. As previously described, the cost of the package shipment can depend upon a variety of factors, including the package weight, type, dimensions, the level, the shipping service requested, delivery, whether return service has been requested by the sender, the distance of package between the sender and recipient's addresses, etc. The processor 208 transmits the transaction data 114 including cost data 115, the procurement card data 110, and the reference data 118, to the computer 302 of the PCP 30 over the network 308.

In FIG. 10, the carrier computer system 2000 includes the computer 202 and the database storage unit 204, as shown in FIG. 9. Moreover, the computer 202 of FIG. 10 includes web server 236 and database server 238. Thus, the program 116 is in effect is distributed between the servers 236, 238. More specifically, the server 236 stores the operating system 216, web server 218, security software 220, shipment application 222, and interface software 224. The server 236 also stores the web pages 1048, 1049, 1051. The server 238 stores the database management software 226 and also the operating system 216. As the example of FIG. 10 makes clear, the functions of the computer program 116, and for that matter those of other computer systems disclosed herein, can be distributed among different computer or servers operating in a network environment. It is therefore expressly stated that the disclosed invention encompasses those circumstances in which functions of a single computing unit described herein are performed by a plurality of units. The web server 236 is connected to the switch 240 which switches the physical communication path of the signals and data traffic to either the router 242 or the remainder of the carrier computer network 206, based on the address included in data packets transmitted from the server 236. Based on the network address indicated by the data packets from server 236, the switch 240 directs such data packets to physical paths leading to either the router 242 or the remainder of the computer network 206. The router 242 is connected to the switch 240 and routes traffic according to the table stored in its memory. More specifically, the router 242 translates the network address of packets received by such router 242 from the web server 236, into a physical address or MAC of the machine to which the network traffic is directed. In FIG. 10, the relevant network packets are directed to the database server 238, and the router 242 performs address translation to direct the data packets to the database server 238. The database server 238 receives such packets via the operating system 216 and executes the database management software 226 to perform the function requested by the web server 236 in executing the shipment application 222. For example, these actions could include storing the sender ID data 106 in association with the carrier account data 108, or the carrier account data 108 in association with the procurement card data 110, to establish the records 230, 232, respectively, in the database storage unit. Furthermore, such action can include accessing the authorization list 228 to determine that the sender 110 is authorized to access the carrier computer system 200 based on the sender ID data 106 received from the Sender. The database management software 226 can also execute instructions from the web server 236 in executing the shipment application 222, to Store shipment data 112, transaction data 114 including cost data 115 generated based on the shipment data 112, in the database storage unit 204. Data retrieved from the database management software 226 to be provided to the web server 236 via operating system 216, router 242, and switch 240 flows in a reverse direction to the web server 236. Data from the database storage unit 204 is transmitted by the database management software 226 using the operating system 216 by generating data packets with addresses that are translated by the router 242 into corresponding network addresses. The translated data packets are provided to the switch 240 which examines their addresses and forwards the data packets via the appropriate physical communication path to the web server 236 for use in executing the shipment application 222. As shown in FIG. 10, the web server 236 is connected to the network 308 to communicate with the PCP 30 and/or a third party data processor.

In FIG. 11A, a method performed by the carrier computer system 200 is shown. In step S1100, the carrier computer system 200 receives a URL from the sender's computer 102 over the network 134, which requests access to the shipment application 222. In step S1102, the carrier computer system 200 retrieves the authorization list 228 from the database storage unit 204. In step S1104, the carrier computer system 200 determines whether the sender 110 is authorized to access the shipment application 222. If the carrier computer system 200 determines that the sender 110 is not authorized to access the shipment application 222, in step S106, the carrier computer system 200 transmits a web page with a message refusing access to the sender to use the shipment application 222. Alternatively, if in step S1104, the sender 110 is authorized to access the shipment application 222, in step S1108, the carrier computer system 200 transmits the web page 1048 prompting the sender 1102 to enter sender ID data 106 using the computer 102. In step S1110, the carrier computer system 200 receives the web page 1048 with sender ID data 106 input by the sender 110 from the sender's computer 102 over the network 134. In step S1112, the carrier computer system 200 retrieves carrier account data 108 corresponding to the sender ID data 106 from the carrier database storage unit 204. In step S1114, the carrier computer system 200 uses the carrier account data 108 to retrieve procurement card data 110 from the carrier database storage unit 204. In step S1116 of FIG. 11B, the carrier computer system 200 generates the web page 1049 prompting the sender 110 to input shipment data 112 and reference data 118. In step S1118, the carrier computer system 200 transmits the web page 1049 to the sender's computer 102. In step S1120, the carrier computer system 200 receives the shipment data 112 and reference data 118 in the web page 1049 returned by the senders' computer 102 via the network 134. In step S1122, the carrier computer system 200 determines whether the shipment data 112 and the reference data 118, are proper, i.e., complete and in the correct format. In step S1124, if the data are not in proper form, in step S1126, the carrier computer system 200 transmits a web page prompting correction of such data to the sender's computer 102 over the network 134. Alternatively, if in step S1124, the data is determined by the carrier computer system 200 to be in proper form, in step S1128, the carrier computer system 200 generates tracking number data for the shipment transaction underway. In step S1130 of FIG. 11C, the carrier computer system 200 generates the web page 1051, including the shipment label 136 with tracking number data 234, and shipment data 112 including the recipient's address, indicated in scannable form. In step S1130, the carrier computer system 200 transmits the web page 1051 with the shipment label 136 in signal form over the network 134 to the sender's computer 102. In step S1132, the carrier 20 picks up the package from the sender for delivery to the recipient 60. In step S1134, the carrier 20 scans the shipment label 136 attached to the package 40 before shipment commences. In step S1136, the carrier 20, or more particularly, the scanning device 140 (see FIG. 3), transmits the scanned data from the shipment label 136 to the carrier computer system 200 for tracking. In step S1138, the carrier computer system 200 stores the pickup date and time in the data base storage unit 204 in association with the tracking number. In step S1140, the carrier 20 transports the package 40 the recipient 60. In step S142 of FIG. 1I D, the carrier 20 scans the shipment label 136 for the package 40 before delivery to the recipient 60. In step S1144, the carrier 20, or more particularly, the person 146, transmits the scanned data from the shipment label 136 to the carrier computer system 200 via the network 206. In step S146, the carrier 20 delivers the package 40 to the recipient 60. In step S1148, the carrier computer system receives the scanned data indicating completion of delivery of the package 40 the recipient 60. In step S11152, the carrier computer system 200 transmits the transaction data 114, including the cost data 115, the reference data 118, and the procurement card data 110, to the PCP computer system 300 via the Network 11308. In step S1154, the carrier 20 receives notification of payment of the cost for shipment from the carrier's bank 90. In step S1156, the carrier 20 instructs its bank 90 to transfer payment for any taxes and/or customs duties due for the shipment of the package 40, to the government bank 95. After performance of step S1156, the method of FIGS. 1A-1D ends.

In FIG. 12, the PCP computer system 300 is shown in relative detail. The PCP computer system 300 comprises the computer 302 and the database storage unit 304. The database storage unit 304 stores the relationship between the procurement card data 10 and the cost center ID data 121. The computer 302 comprises processor 306, memory 308, interface unit 310, connected to bus 312. The memory 308 stores operating system 314, web server 316, security software 318, invoice application 320, interface software 322, and database management software 324. The processor 306 executes the operating system 314 to communicate with the database storage unit 304 and the interface unit 310 via the bus 312. The processor 306 executes the web server 316 to communicate with the computer 104, and optional third-party data processor 70. The processor 306 executes the security software 318 to prevent unauthorized access to the PCP computer system 300 and to encrypt and decrypt data transmitted over networks 308, 310, 312. The processor 306 executes the invoice application 320 to generate invoice data 326. The processor 306 stores the invoice data 326 in the database storage unit 304. The processor 306 executes the interface software 322 to link the invoice application 320 to the operating system 314 so that execution of the invoice application can utilize data transmitted to and received from the database storage unit 304 and the interface unit 310. The database management software 324 is executed by the processor 306 to permit the processor 306 to use the data stored in the database storage unit. The processor 306 can use the database management software 324 to access or read, write, modify and/or delete data stored in the database storage unit 304.

The processor 306 receives the procurement card data 110, the reference data 118, and the transaction data 114 with cost data 115, from the carrier computer system 200 via the interface unit 310. The processor 306 stores the procurement card data 110, the reference data 118, and the transaction data 114 including the cost data 115, in the memory 308. The processor 306 executes the invoice application 320 to use the procurement card data 110 to reference the database storage unit 304 with the database management software 324, to retrieve the corresponding cost center ID data 121. The processor 306 retrieves the corresponding reference data 118 from the memory 308, and prepares the invoice data 326 as a table including the cost center ID data 121 and the reference data 118. The processor 306 can execute the invoice application 320 for a single shipment transaction. However, the transaction data 114 can be supplied from the carrier computer system 200 for a plurality of shipment transactions accumulated over a period of time, such as one week, for batch processing. Also, the PCP computer system 300 can accumulate transaction data for use of the procurement card 50 for purposes other than shipment of a package. Thus, the invoice data 326 can include transaction data 114 and respective cost data 115 for one or more transactions occurring over a period of time, for example, one week. The processor 306 can execute the invoice application 320 to transmit the invoice data 326 over the network 312 to the PCH computer 104 via the server 144. The processor 306 can also execute the invoice application 320 to transmit the invoice data 326 to the computer system 700 of the third-party data processor 70 via the network 310. Upon payment of the total of the cost data 115 for the transactions included in the invoice represented by invoice data 326, the PCP computer system 300 is notified by the PCP bank 85 that payment has been received from the PCH 10. More specifically, the PCP bank 85 can transmit notification data 328 via the network 312 to the processor 306 via the interface unit 310 and bus 312. The processor 306 can also store the notification data 328 in correspondence with the invoice data 326 so that the settlement of the invoice is stored with the invoice data to indicate payment has been made. The processor 306 executes the invoice application 320 to generate instruction data 330 to instruct the PCP bank 85 to transmit funds for the cost of shipment to the carrier bank 90. In response to receiving the instruction data 330, the PCP bank 85 transmits the funds for the shipment cost to the carrier bank 90. The carrier bank 90 notifies the carrier computer system 200 of receipt of the funds from the cost of shipment PCP bank 85. In response to this notification, the carrier computer system 200 transmits instructions to the carrier bank 90 to transmit funds to the government bank 95 to cover sales taxes and/or customs duties due for the shipment. The carrier bank 90 then transmits the funds over the network 312 to the government bank 95 to accomplish payment of the sales tax and/or customs duties.

In FIG. 13, a method performed by the PCP computer system 300 begins in step S1300. In Step 1300, the PCP computer systems 300 receives the procurement card data 110, reference data 118, and transaction data 114 including cost data 115, from the carrier computer system 200 over the network 308. In step S1302, the PCP computer system 300 uses the procurement card data 110 to reference the database storage unit 304 to retrieve corresponding cost center ID data 121. In step S1304, the PCP computer system 300 generates invoice data 326 including cost center ID data 121, reference data 118, and transaction data 114 including cost data 115. In step S1306, the PCP computer system 300 transmits the invoice data 326 to the computer 104 of the PCH 10. In step S1308, the PCP bank 85 notifies the PCP computer system 300 of receipt of funds for the payment 124 corresponding to the Invoice represented by data 326, by the PCH 10. In step S1310, the PCP computer system 300 generates instruction data 330 to instruct the PCP bank 85 to transmit funds for shipment cost represented by cost data 115 to the carrier computer system 200.

In FIG. 14, the computer system 700 of the third party data processor 70 is shown in relative detail. As previously described, the computer system 700 comprises of computer 702 and database storage units 704. The computer 702 comprises of processor 706, memory 708, interface unit 710, connected to bus 712. The memory 708 stores operating system 714, web server 716, security software 718, listing application 720, interface software 722, and database management software 724. The processor executes the operating system 714 to communicate with the database storage unit 704 and the interface unit 710. The processor 706 executes the web server 716 to interact with the PCP computer system 300 and the computer 104 of the compute system 100 of the PCH 10, using HTTP and TCP/IP protocols. The processors 706 executes the security software 716 to implement security features of the computer system 700. More specifically, the security software 718 can comprise of a firewall executed by the processor 706 to prevent unauthorized access of the computer system 700. The security software 718 can also effect encryption and decryption of signals and data transmitted to and from the computer system 300 of the PCP 30, and the computer 104 of the PCH 10. The processor 706 executes listing application 720 to generate a listing 726 of transaction data 114 including cost data 115, in correspondence with the respective cost center ID data 121 and reference data 118. The processor 706 executes the interface software 722 to link the listing application 720 to the operating system 714 so that data for listing applications can effectively transmit data to and from the database storage unit 704 and the interface unit 710. The database management software 724 can be executed by the processor 706 to interact with the database storage unit 704, which can include reading, writing, modifying, and/or deleting data storage in the database storage unit 704 by the processor 706 as it executes the database management software. The interface software 722 can be used to indicating link the database management software 724 to the operating system 714 so that the processor 706 can communicate with the database storage unit 704 and the interface unit 710 as it executes the data base management software unit.

In operation, the processor 706 receives the invoice data 326 including the cost center ID data 121, the reference data 118, and the transaction data 114 including respective cost data 115. The processor 706 executes the database management software 724 and the operating system 714 to store the invoice data 326 in the database storage unit 704. As previously described, one or more functions of the carrier computer system 200 and the PCP computer system 300 can be executed by a third party data processor such as the entity 70. This, for example, the invoice data 326 could include procurement data 110 in place of the cost center ID data 121. In this case, the third party data processor computer system 700 can store the relationship between the procurement card data 110 and the cost center ID data 121 in the database storage unit 704. The computer system 700, more specifically, the processor 706, can use a relationship in the record 726 between the procurement card data 110 and the cost center ID data 121, to replace the procurement card data in the invoice data 326 with the appropriate cost center ID data 121. The invoice data thus identifies the appropriate cost data and subcategory thereof for use the accountant 120 at the PCH 10 to apply the cost of shipment to the appropriate cost center and subcategory thereof.

When the accountant 120 at the PCH 10 desires to access the invoice data 326, the accountant 120 operates the computer 104 to indicate the URL 727 specifying the file name and path to the listing application 727. In response to receiving the URL 727, the processor 706 can prompt the accountant 120 to input ID data, such as a user name and password. The processor 706 checks the ID data against authorization list 729. If the processor 706 determines that the accountant 120 is not authorized to access the invoice data 326, the processor 706 generates and transmits a web page to the computer 104 to inform the accountant that such person is not authorized to access the invoice data. Alternatively, if the processor 706 determines that the login ID or user name and password provided by the accountant 120 using the computer 104 are present in the authorization list 729, the processor 706 launches the listing application 720. More specifically, the processor 706 receives the URL 727 and retrieves the listing application 720 based on the URL 727. The processor 706 executes the listing application 720 to generate the listing 728 including the invoice data 326 with the cost center ID data 121, and corresponding reference data 118 and transaction data 114 with cost data 115. The processor 706 further executes the listing application 720 on the web server 716 to embed the listing 728 in the web page 730. The processor 706 transmits the web page 730 to the computer 104 operated by the accountant 120 at the PCH 10 via the bus 712, the interface unit 710, and the network 311.

Alternatively, rather than a initiating launch of the listing application 720 in response to receiving a request from the accountant 120 via the computer 104 (i.e., the “pull” mode of operation), the computer system 700 can implement a “push” mode of operation, by generating the listing 728 and transmitting same to the computer 104 for use by the accountant 120. The computer system 700 can generate the listing 728 and transmit same to the computer 104 in response to receiving the invoice data 326, either immediately upon receipt of such data or on a periodic basis, such as once per week.

In FIG. 15, a method performed by the third party data processor computer system 700 begins in step S1500. In step S1500, the data processor computer system 700 receives invoice data 326 including cost center ID data 121 (or procurement card data 110), reference data 118, and transaction action data 114 including cost data 115, from the PCP computer system 300. In step S1502, if the invoice data includes procurement card data 110, the data processor computer system 700 retrieves corresponding cost center ID data 121 from the database storage unit 304 and stores same in correspondence with the invoice data 326. In step S1504, the data processor computer system 700 receives a request for the listing 728 from the PCH system 100. This step is implemented in the “pull” mode of operation of the data processor computer system 700. If the request has not yet been received from the PCH computer system, the data processor computer system 700 will perform the step S1504 at a later time. Alternatively, if the determination is step 1504 is affirmative, or if a “push” mode of operation is used by the data processor computer system 700, the processing precedes to step S1506 in which the data processor computer system generates listing 728 of the cost center ID data 121 and corresponding reference data 118 and transaction data 114 including cost data 115, for transactions included in the invoice represented by data 326. In step S1508, the data processor computer system 700 generates web page 730 including the listing 728. In step S1510, the data processor computer system 700 transmits the web page 730 including the listing 728 to the accountant's PCH computer 106 over the network 311.

In FIG. 16, the computer 104 of the PCH 10 is shown in relative detail. The computer 104 comprises processor 160, memory 162, input device 164, output device 166, a network interface card (NIC) 168 and/or modem 170, and printer interface card (TIC) 172, connected to bus 174. The memory 162 stores BIOS 176, operating system 178, and API 180. Moreover, the memory 162 stores browser application 182 and accounting software 184. As previously described, the processor 160 executes the BIOS 176 upon power up of the computer 104. The BIOS is stored in non-volatile memory and assists the processor 160 in retrieving the operating system 178 from a hard-disk data storage unit of memory 162 so that such processor can communicate with the other elements of the computer 102 via the bus 174.

In operation, the accountant 120 uses the graphical user interface (GUI) 126 defined by input device 164, the output device 166, and the processor 160 as it executes the browser application 182 and accounting software 184. The accountant 120 operates the input device 164, or more specifically the keyboard 1640 or mouse 1642 thereof, to launch the browser application 182. In response to the accountant's operation of the input device 164, the processor 160 retrieves the browser application 182 from the memory 162 and executes same. In execution of the browser application 182, the processor 160 generates display 188 which includes a browser GUI 190. The accountant 120 further uses the input device 164 to enter the network address 192, e.g., a URL, for the data processor computer system 700 into the address field of the browser GUI 190. In response to entry of the network address 192, the processor 160 generates a signal requesting the PCP computer system 300 and/or third party data processor computer system 700, to permit the accountant 120 to access the invoice data 326 via the computer 104. The PCP computer system 300 and/or data processor computer system 700 transmits the web page 194 requesting the accountant 120 to enter identification data 196, to the PCH computer 104 via respective networks 311, 312. The accountant 120 enters the accountant ID data 196 into the appropriate field of the web page 194 using the input device 164. The account ID data 196 can be in the form of a logon id or user name, and password. In response to the accountant 120 entering the accountant's ID data 196 using the input device 164, the processor 160 transfers the web page 194 including the accountant ID data 196, from the computer 102 to the third party data processor computer system 700 and/or PCP computer system 300 via the bus 174, and modem or NIC 168. Assuming the accountant 120 is authorized to access the invoice data 326, the third party data processor computer system 700 and/or PCP computer system 300, responds with the web page 730 including the listing 728. The listing 728 includes invoice data 326 with cost center ID data 121, reference data 118, and transaction data 114. The transaction data includes the cost data 115 for one or more respective transactions.

The accountant 120 can launch the accounting software 184 by operation of the input device 164. In response to activation, the processor 160 launches the accounting software 184 and uses the API 180 to link such accounting software to the operating system 178. The processor 160 further executes the accounting software 184 to retrieve the cost center ID data 121 and the corresponding reference data 118 and transaction data 114 with cost data 115, and stores same as accounting data 198. Using the cost center ID data 121, and the reference data 118, the processor 160 executes the accounting software 184 to apply the cost indicated by data 115 to the corresponding cost center 122 and subcategory 123. The processor 160 further executes the accounting software 184 to sum the cost data 115 to determine a total amount due for the invoice represented by data 326. The processor generates payment data 199 based on the total of the cost data 115. The payment data 199 includes data instructing the PCH bank 80 to transfer bank funds for the invoice total of the cost data 115, to the PCP bank 185. The processor 160 transmits the payment data 199 to the carrier bank 80 to effect the funds transfer.

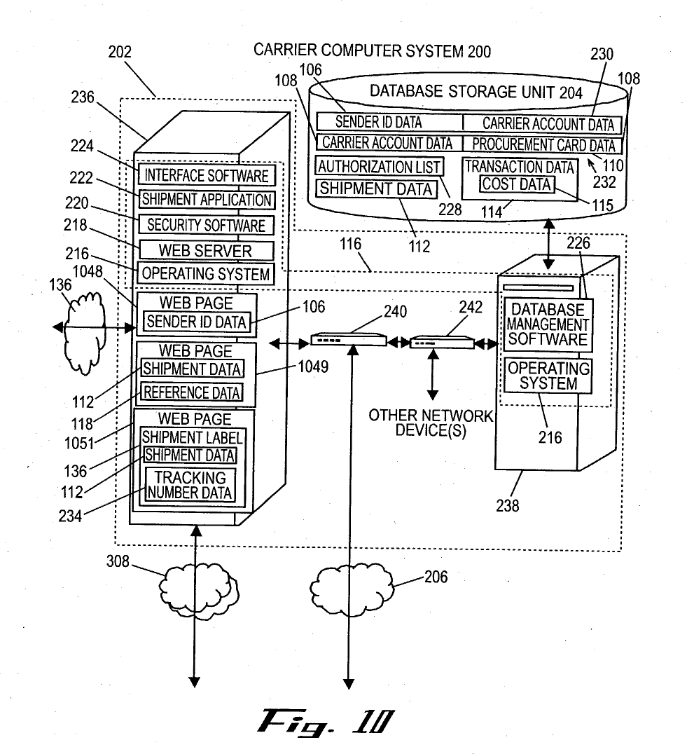

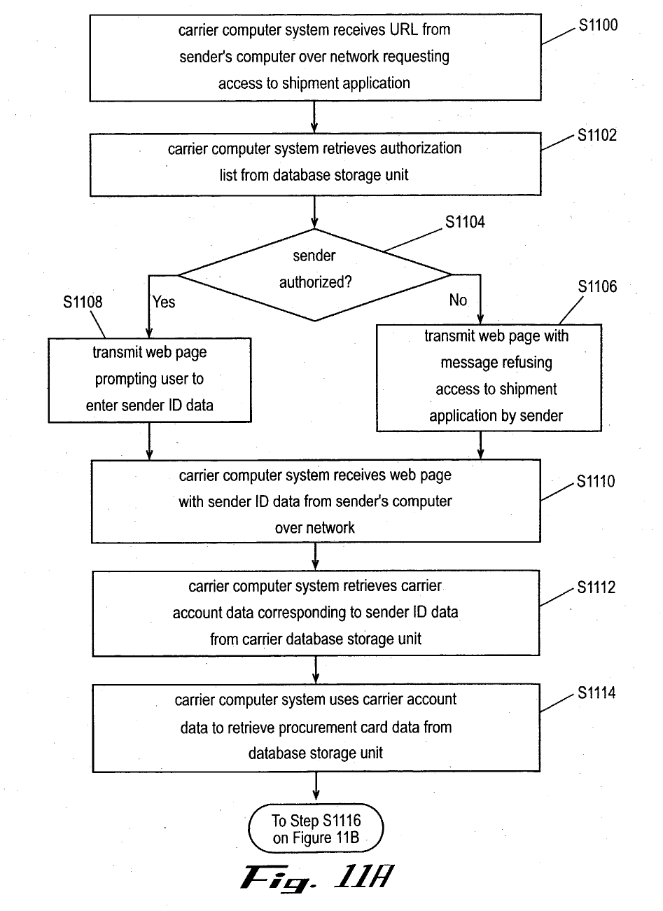

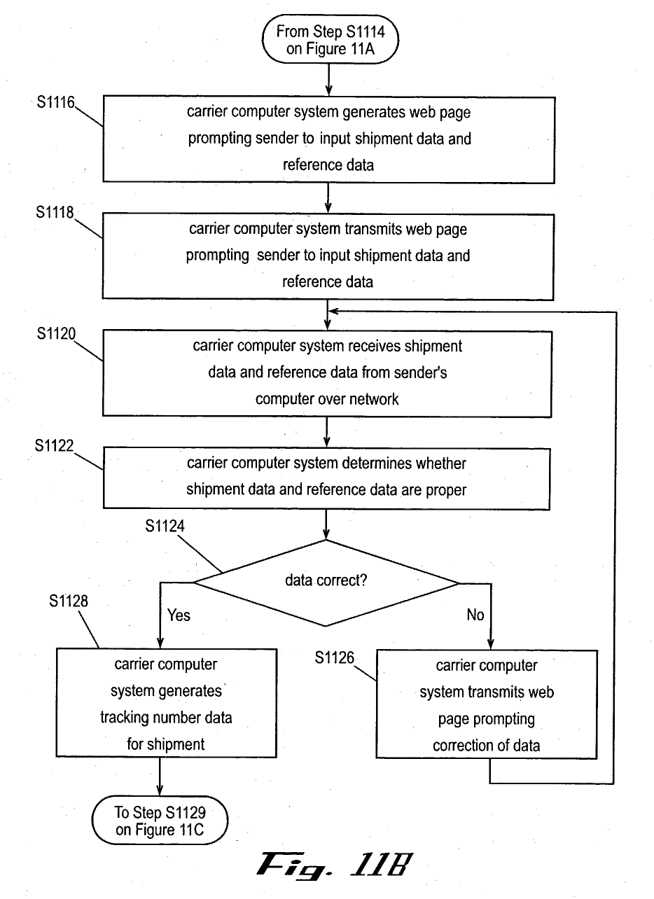

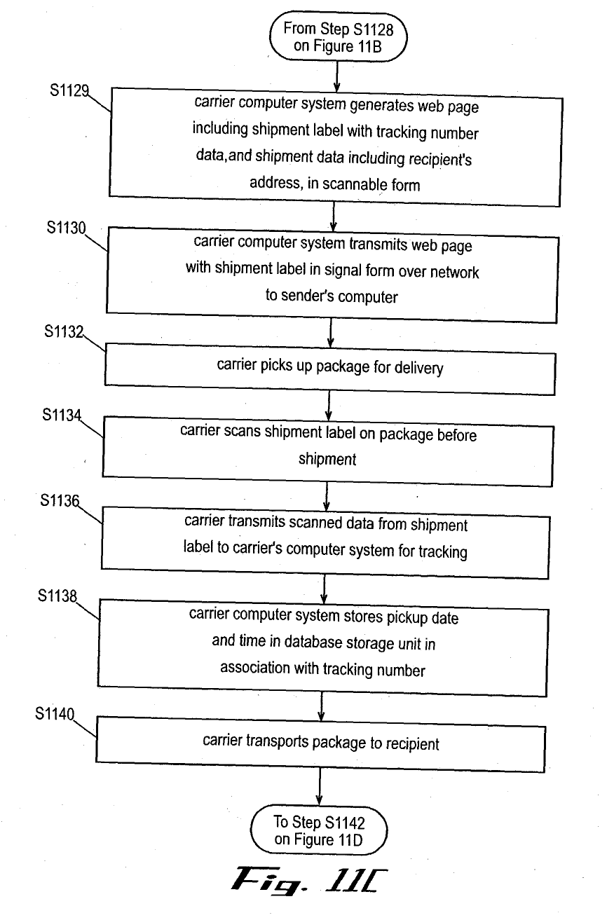

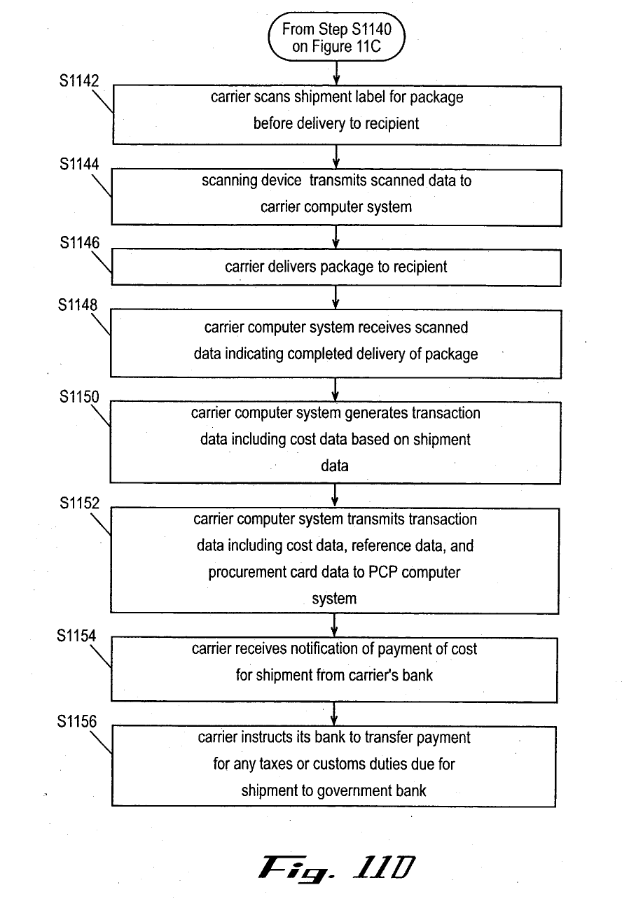

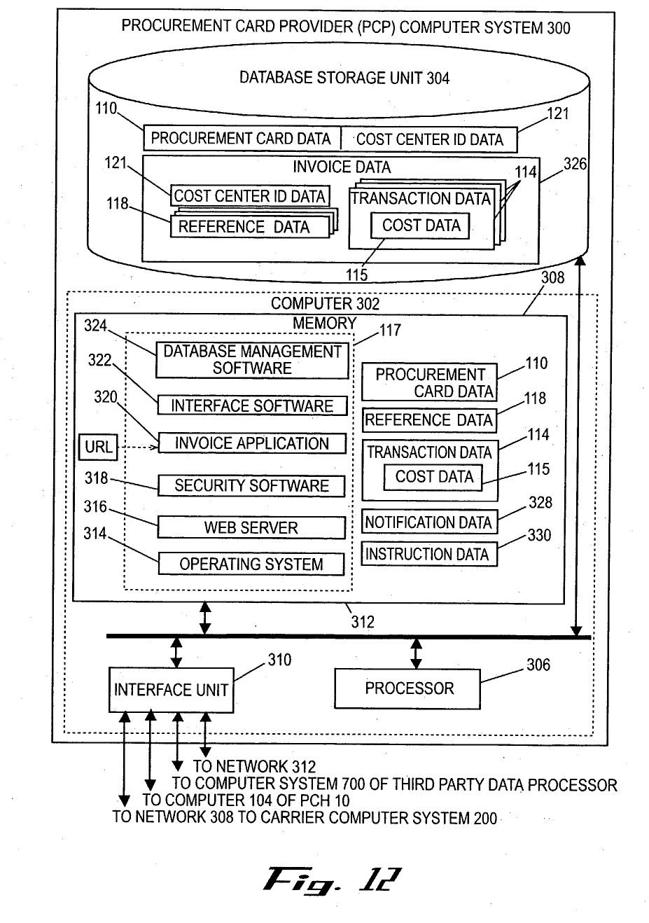

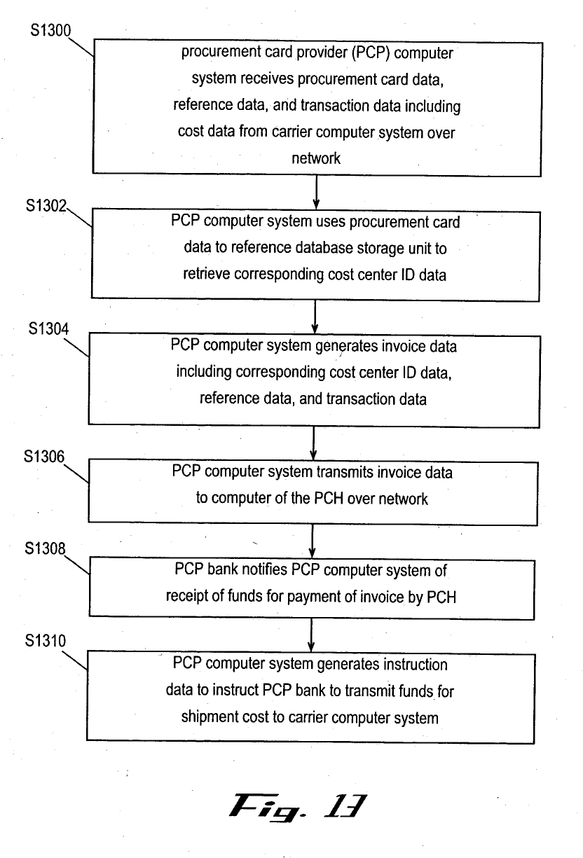

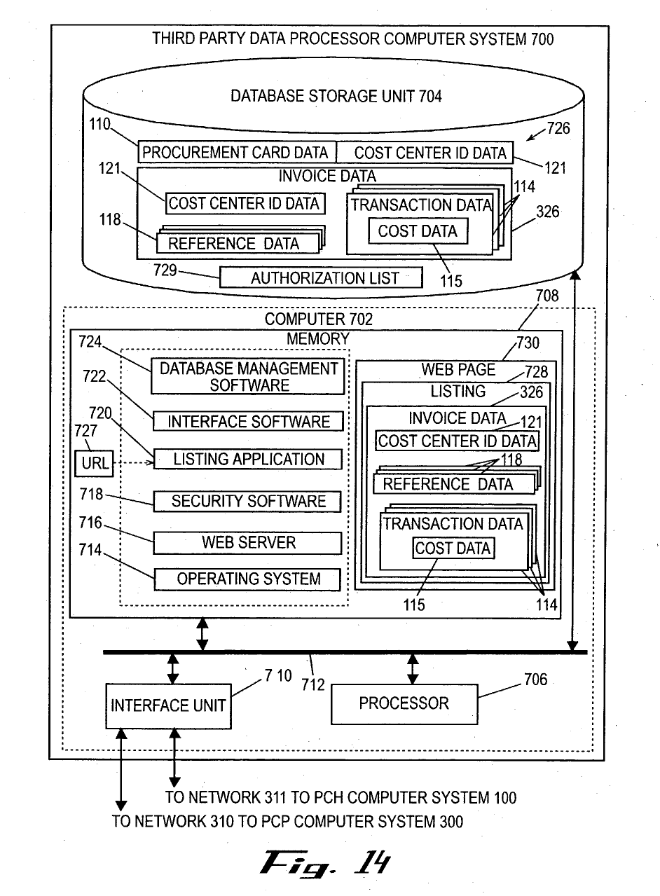

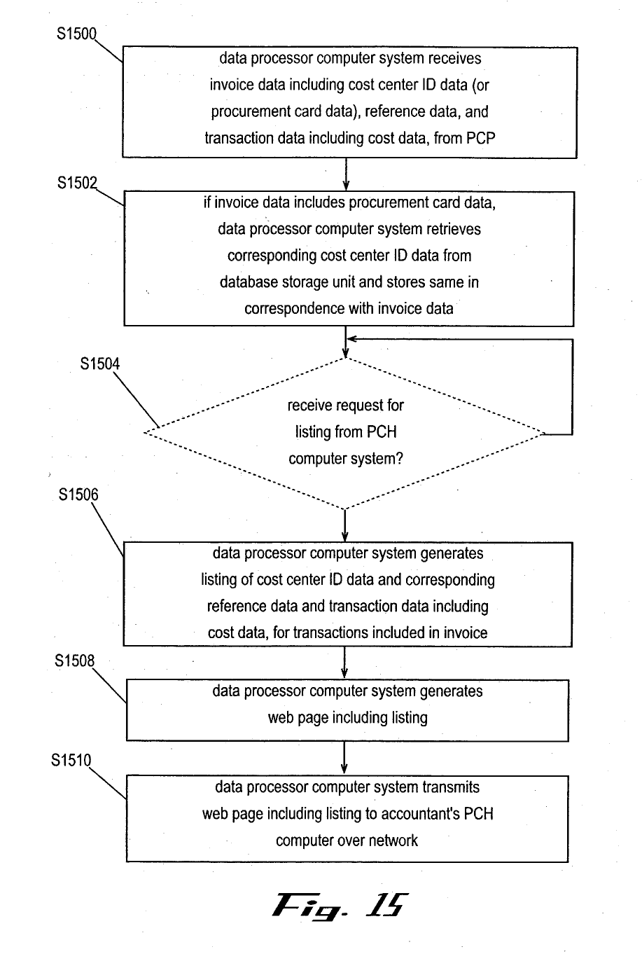

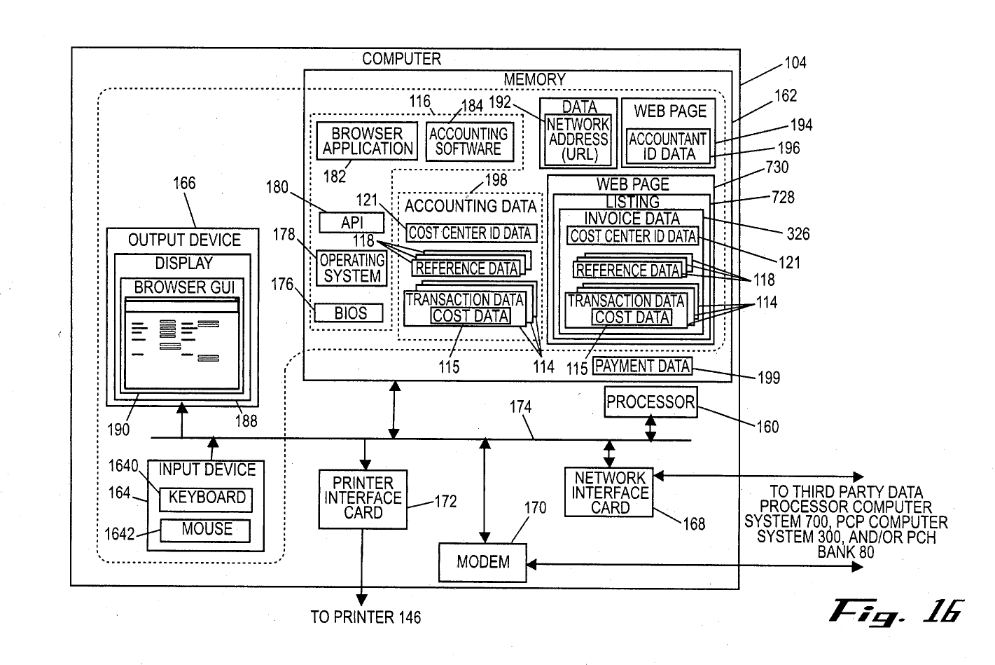

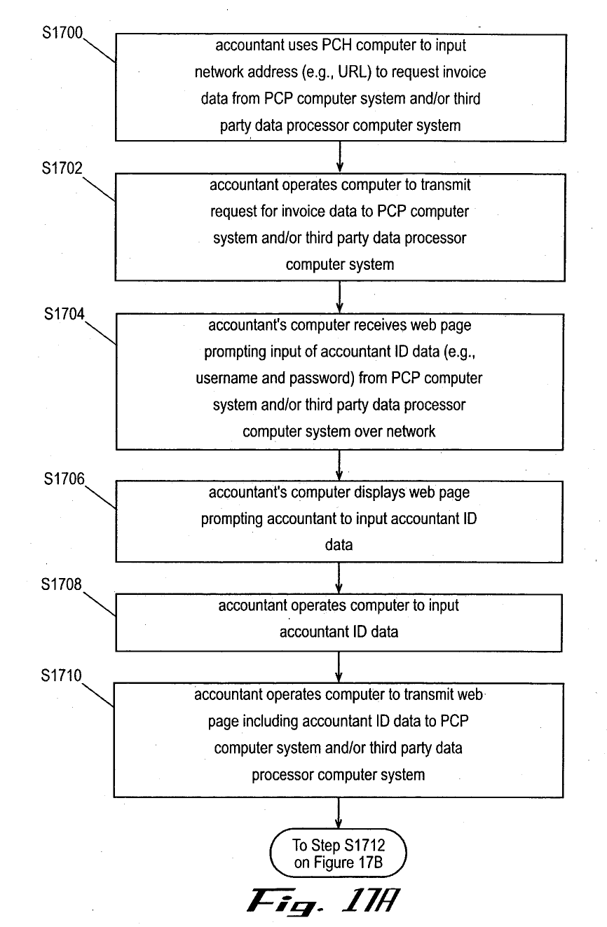

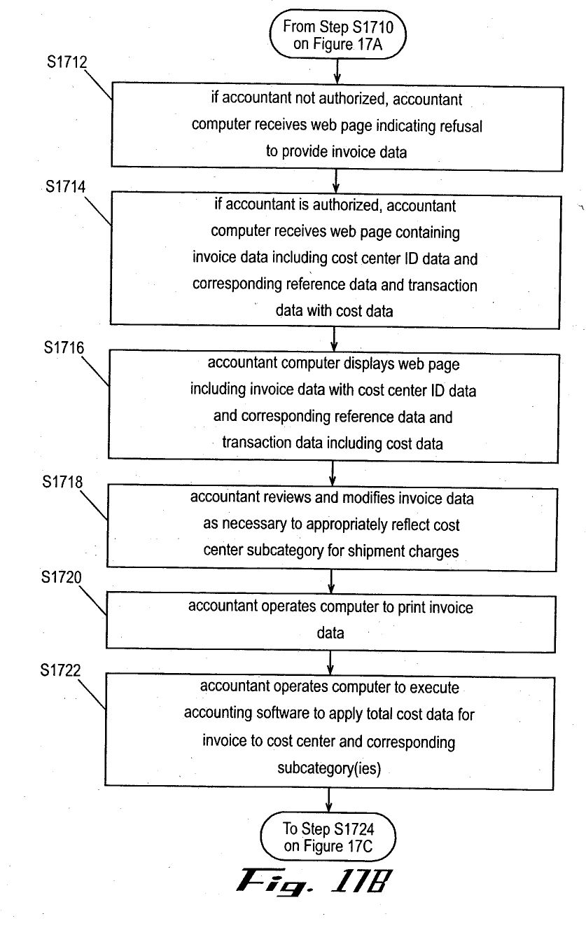

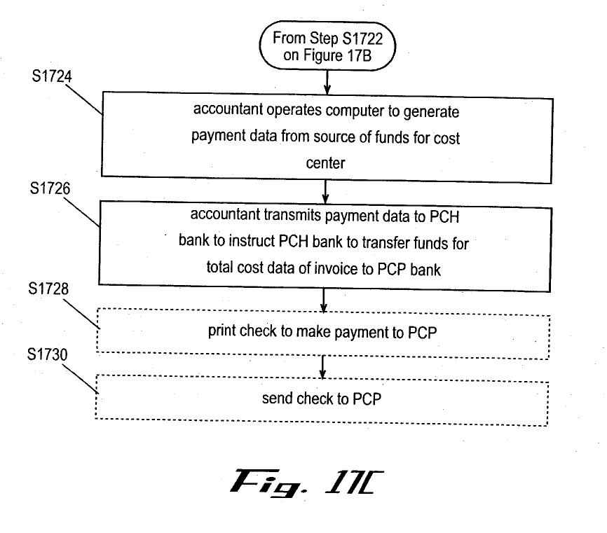

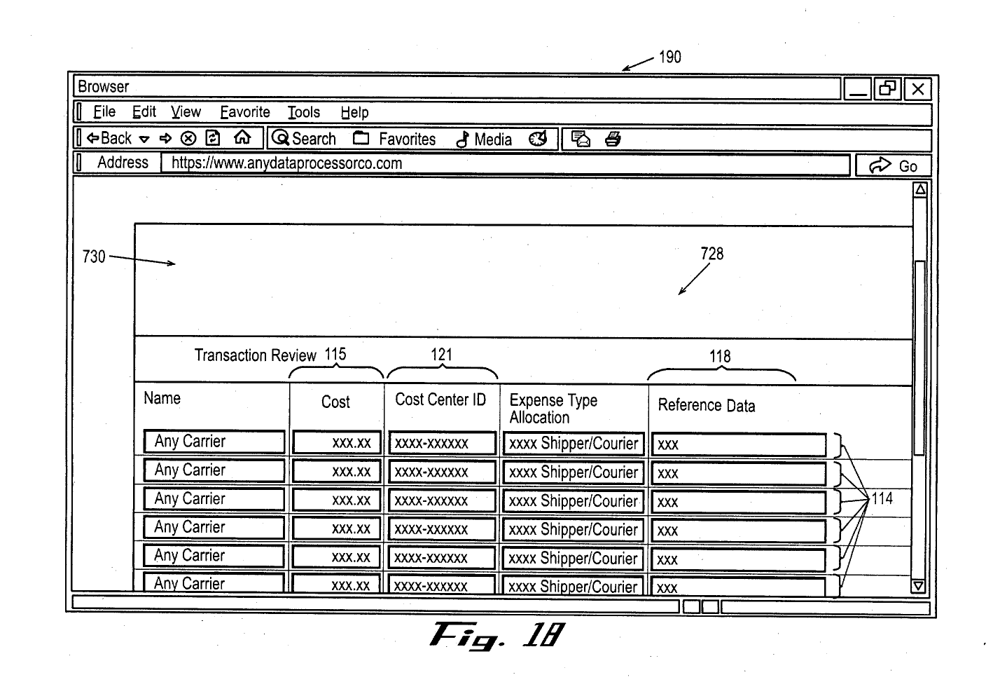

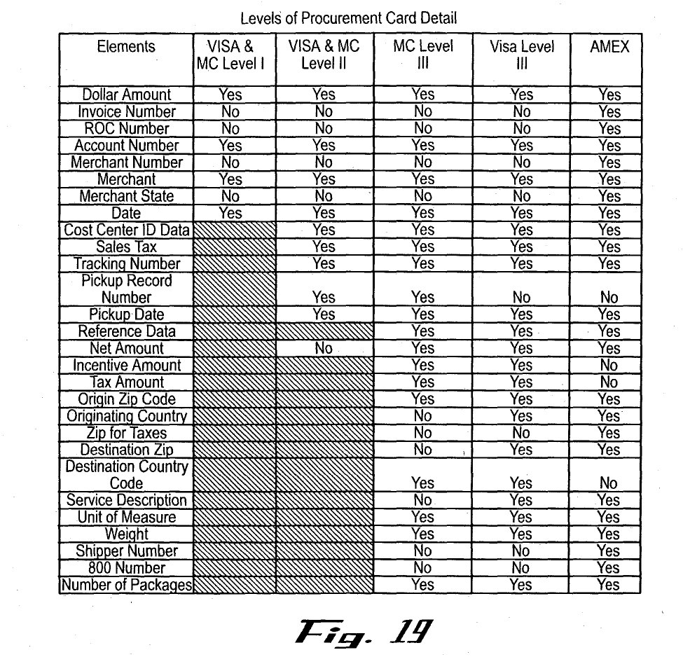

In FIGS. 17A-17C, a method performed by the accountant 120 using the computer 104, is described. In step S1700, the accountant 120 uses the PCH computer 104 to input network address (e.g., a URL) 727 into the address field of the browser application 182 to request the invoice data 326 from the PCP computer system 300 and/or third party data processor computer system 700. In step S1702, the accountant operates a computer 104 to transmit invoice data 326 to the PCP computer system 300 and/or third party data processor computer system 700. In step S1704, the accountant's computer 104 receives web page 194 prompting input of accountant ID data (e.g., user name and password) 194 from PCP computer system 300 and/or third party data processing computer system 700 over the respective network 311, 312. In step S1706, the accountant's computer 104 displays the web page 194 prompting the accountant 120 to input accountant ID data 196. In step S1708, the accountant operates a computer 104 to input the accountant ID data 196. In step S1710, the accountant 120 operates the computer 104 to transmit the web page 194 including the accountant ID data 196 to the PCP computer system 300 and/or third party data processor computer system 700 via respective network 311, 312.

In step S1712, if the accountant is determined not to be authorized to access the invoice data 326 by the PCP computer system 300 and/or third party data processor computer system 700, the accountant computer 104 receives a web page indicating refusal to provide invoice data 326 to the accountant 120. Conversely, if the accountant is authorized to access the invoice data 326, the accountant computer 104 receives the web page 730 containing invoice data 326 with cost center ID data 121 and corresponding reference data 118 and transaction data 114 including cost data 115. In step S1716, the accountant computer system 104 displays the web page 730 including the invoice data. In step S1718, the accountant 120 reviews and modifies the invoice data 326 as necessary to appropriately reflect the cost center's subcategory 123 for shipment charges. In a typical case, the sender 110 enters the appropriate reference data 118 for the cost center subcategory 123 so that modification of the invoice data 326 received at the computer 104, is generally not necessary. However, in those instances which the sender 110 has entered incorrect data 118, the accountant 120 has the capability to modify the reference data appropriately to reflect the cost center subcategory. In step S1720, the accountant 120 operates the computer 104 to print the invoice data 326 with any modification. The printed invoice data can be stored or filed for later payment. In step S1722, the accountant 120 operates the computer 104 to execute the accounting software 184 to apply the total cost data 115 for the invoice to the appropriate cost center 122 and subcategory(ies) 123. In step S1724 of FIG. 17C, the accountant 120 operates the computer 104 to generate the payment data 199 from a source of funds, e.g., a bank account, for the cost center corresponding to the cost ID data 121. In step S1726, the accountant 120 transmits to payment data 199 to the PCH bank 80 to instruct the PCH bank to transfer the funds for the total cost data covered by the invoice to the PCP bank 85. Alternatively, in lieu of steps S1724 and S1726, steps S1728 and S1730 can be implemented. In step S1728, the accountant 102 uses the computer 104 to print a check to make payment for the total cost of the invoice to the PCP bank 80. In step S1730, the accountant 120 mails the check to the PCP 30.

FIG. 18 is a view of web page 720 as executed by the browser application 182 of the computer 104 to generate browser GUI display 190. The browser display 190 includes the listing 728 of transaction 114 on successive lines. Respective columns of the listing 728 indicate the cost data 115, the cost center ID data 121, and the reference data 118 corresponding to each transaction 114. The cost center 122 and subcategory 123 can be readily determined from the listing 728. The accountant 120 can modify the reference data 118 to change it to the appropriate cost center subcategory 123 in the event such data is inaccurate.

FIG. 19 indicates various levels of procurement card detail that can be transmitted by different procurement card companies. It will be appreciated that in order to transmit reference data 118 from the PCP 30 and/or a third party data processor 70, it is necessary to use “Level 3” detail. Use of Level 3 detail ensures that a field will be available for the reference data 118 and that such data will not be omitted in processing by the PCP 30 or any third party data processor associated therewith.

1. (new) a system for use in shipping a package and charging shipment cost to a corresponding cost center using a procurement card, the system comprising:
a procurement card holder (PCH) computer system having at least one computer for entering sender identification (ID) data identifying a sender of a package, shipment data indicating at least one characteristic of the package, and reference data identifying a sub-category of a cost center to which the cost of shipment of a package is to be charged;
a carrier computer system connected to communicate with the PCH computer system, the carrier computer system receiving the sender ID data, shipment data, and reference data from the PCH computer system, the carrier computer system using the sender ID data to retrieve corresponding procurement card data from a database of the carrier computer system, the carrier computer system generating transaction data including cost data based on the shipment data; and
a procurement card provider (PCP) computer system connected to communicate with the PCP computer, the PCP computer system receiving the sender ID data, transaction data, and reference data from the carrier computer system, the PCP computer system using the procurement card data to retrieve corresponding cost center ID data from a database of the PCP computer system, the PCP computer system transmitting the cost center ID data, reference data, and transaction data to the PCH computer system,
the PCH computer system receiving the cost center ID data, reference data, and transaction data from the PCP computer system, and using the cost center ID data and reference data to identify the cost center and sub-category thereof, respectively, for payment of the shipment cost represented by the cost data.

2. (New) A system as claimed in claim 1 wherein the sender ID data comprises a user name and password.

3. (New) A system as claimed in claim 1 wherein the shipment data comprises data identifying at least one of the following characteristics: weight, dimensions, contents of the package, distance over which the package is to be shipped as indicated by the sender's and recipient's addresses, and/or the level of service or speed of delivery of the package from sender to recipient.

4. (New) A system as claimed in claim 1 wherein the cost center data identifies at least one of a bank account, a grant fund, and a source of funds held by the PCH.

5. (New) A system as claimed in claim 4 wherein the carrier transports the package from the sender to a recipient and generates the transaction data thereafter.

6. (New) A system as claimed in claim 1 wherein the database of the carrier computer system associates sender ID data with carrier account data, and carrier account data with procurement card data, to associate the sender ID data with the procurement card data corresponding to the cost center to be charged for the package shipment cost.

7. (New) A system as claimed in claim 1 wherein the data transmitted from the carrier computer system to the PCP computer system, and the PCP computer system to the PCH computer system, comprises Level III detail.

8. (New) A computer system for use in shipping a package and charging shipment cost to a corresponding cost center using a procurement card, the computer system comprising:
at least one computer for entering sender identification (ID) data identifying a sender of a package, shipment data indicating at least one characteristic of the package, and reference data identifying a sub-category of a cost center to which the cost of shipment of a package is to be charged, the PCH computer system receiving cost center ID data corresponding to the sender ID data, the reference data, and transaction data including cost data indicating the cost of shipment, and using the cost center ID data and reference data to identify the cost center and sub-category thereof, respectively, for payment of the shipment cost represented by the cost data.

9. (New) A computer system as claimed in claim 8 wherein the computer system is used to produce a payment for the shipment cost from the cost center identified by the cost center ID data.

10. (New) A computer system as claimed in claim 8 wherein the computer system is used to apply payment for the shipment cost to the cost center and sub-category thereof identified by the cost center ID data and the sub-category of the cost center as an account payable.

11. (New) A computer system for use in shipping a package and charging shipment cost to a corresponding cost center using a procurement card, the computer system comprising:
a computer receiving sender ID data, shipment data, and reference data, the computer system using the sender ID data to retrieve corresponding procurement card data from a database of the carrier computer system, the carrier computer system generating transaction data including cost data based on the shipment data, and transmitting the transaction data, procurement card data, and reference data.

12. (New) A computer system as claimed in claim 11 wherein the computer system is operated by a carrier.

13. (New) A computer system as claimed in claim 11 wherein the computer system is operated by a third party data processor on behalf of the carrier.

14. (New) A computer system as claimed in claim 11 wherein the computer system is received from a computer system of a procurement card holder.

15. (New) A computer system as claimed in claim 11 wherein the computer system transmits the sender ID data, shipment data, and reference data to a computer system of a procurement card provider via a network.

16. (New) A computer system as claimed in claim 11 wherein the computer system transmits the sender ID data, shipment data, and reference data with Level III detail.

17. (New) A method comprising the steps of:
associating sender identification (ID) data identifying the sender of a package, with carrier account data identifying a carrier account of a procurement card holder (PCH) with which the sender is affiliated; and
associating the carrier account data with procurement card data identifying a procurement card to which shipment cost is to be charged.

18. (New) A method as claimed in claim 17 wherein the association of the sender ID data to corresponding carrier account data, and the carrier account data to respective procurement card data, are stored in a database of a carrier computer system.

19. (New) A method comprising:
receiving sender identification (ID) data, reference data, and shipment data;
retrieving from a database procurement card data associated with the sender ID data;
generating transaction data including cost data indicating cost of shipment of a package, based on the shipment data; and
transmitting the transaction data including cost data, the procurement card data, and the reference data.

20. (New) A method as claimed in claim 19 wherein the sender ID data is used to retrieve corresponding carrier account data, which is in turn used to retrieve the procurement card data, from the database.

21. (New) A method as claimed in claim 19 wherein the method is performed by a carrier computer system.

22. (New) A method as claimed in claim 19 wherein the method is performed by a third party data processor on behalf of a carrier.

23. (New) A method as claimed in claim 19 wherein the sender identification (ID) data, reference data, and shipment data are received from a computer system of a procurement card holder (PCH).

24. (New) A method as claimed in claim 19 wherein the second computer system is operated by a procurement card provider.

25. (New) A method as claimed in claim 19 wherein the computer system transmits the sender ID data, shipment data, and reference data with Level III detail.

26. (New) A method comprising:
receiving transaction data including package shipment cost data, procurement card data, and reference data from a first computer system;
retrieving from a database cost center identification (ID) data corresponding to the procurement card data; and
transmitting the transaction data including the cost data, cost center ID data, and reference data to a second computer system.

27. (New) A method as claimed in claim 26 wherein the method is performed in a computer system of a procurement card provider.

28. (New) A method as claimed in claim 26 wherein the method is performed by a computer system of a third party data processor on behalf of a procurement card provider.

29. (New) A method as claimed in claim 26 wherein the transaction data including cost data, the procurement card data, and the reference data, are transmitted to a computer system of a procurement card holder.

30. (New) A method comprising:
receiving transaction data including package shipment cost data, procurement card data, and reference data;
retrieving from a database cost center identification (ID) data corresponding to the procurement card data; and
transmitting the transaction data including the cost data, cost center ID data, and reference data.

31. (New) A method as claimed in claim 30 wherein the method is performed by a procurement card provider.

32. (New) A method as claimed in claim 30 wherein the method is performed by a third party data processor on behalf of a procurement card provider.

33. (New) A method as claimed in claim 30 wherein the shipment cost data, procurement card data, and reference data are received from a carrier computer system.

34. (New) A method as claimed in claim 30 wherein the transaction data including the cost data, cost center ID data, and reference data are transmitted to a procurement card-holder.

35. (New) A computer system as claimed in claim 30 wherein the computer system transmits the cost data, cost center ID data, and reference data with Level III detail.

36. (New) A method comprising:
entering sender identification (ID) data identifying a sender of a package, shipment data indicating at least one characteristic of the package, and reference data identifying a sub-category of a cost center to which a cost for shipment of a package is to be charged;
transmitting the sender ID data, shipment data, and reference data;
receiving transaction data including cost data generated based on the shipment data, cost center ID data corresponding to the sender ID data, and the reference data;
paying for the shipment cost from the cost center identified by the cost center ID data; and
applying the shipment cost to the cost center and sub-category indicated by the cost center ID data and the reference data, respectively, as an account payable.

37. (New) A method as claimed in claim 36 wherein the method is performed by a computer system of a procurement card holder.

38. (New) A method as claimed in claim 36 wherein the procurement card holder is an institution.

39. (New) A method as claimed in claim 36 wherein the sender ID data, shipment data, and reference data are transmitted to a carrier computer system via a network.

40. (New) A method as claimed in claim 36 wherein the transaction data, cost center ID data, and reference data are received from a procurement card provider.

41. (New) A method as claimed in claim 36 wherein the transaction data, the cost center ID data, and the reference data are received from a third party data processor on behalf of a procurement card provider.

42. (New) A method as claimed in claim 36 wherein the shipment data, cost center ID data, and the reference data are transmitted with Level III detail.

43. (New) A computer-readable medium storing a computer program executable by a computer to perform the following:
associating sender identification (ID) data identifying the sender of a package, with carrier account data identifying a carrier account of a procurement card holder (PCH) with which the sender is affiliated; and
associating the carrier account data with procurement card data identifying a procurement card to which shipment cost is to be charged.

44. (New) A computer-readable medium as claimed in claim 43 wherein the computer program can be executed by the computer to store the association of the sender ID data to corresponding carrier account data, and the carrier account data to respective procurement card data, in a database of a carrier computer system.

45. (New) A computer-readable medium storing a computer program executable by a computer to perform the following:
receiving sender identification (ID) data, reference data, and shipment data;
retrieving from a database procurement card data associated with the sender ID data;
generating transaction data including cost data indicating cost of shipment of a package, based on the shipment data; and
transmitting the transaction data including cost data, the procurement card data, and the reference data.

46. (New) A computer-readable medium as claimed in claim 45 wherein the sender ID data is used to retrieve corresponding carrier account data, which is in turn used to retrieve the procurement card data, from the database.

47. (New) A computer-readable medium as claimed in claim 45 wherein the receiving, retrieving, generating, and transmitting are performed by a carrier computer system.

48. (New) A computer-readable medium as claimed in claim 45 wherein the receiving, retrieving, generating, and transmitting are performed by a third party data processor on behalf of a carrier.

49. (New) A computer-readable medium as claimed in claim 45 wherein the sender identification (ID) data, reference data, and shipment data are received from a computer system of a procurement card holder (PCH).

50. (New) A computer-readable medium as claimed in claim 45 wherein the second computer system is operated by a procurement card provider.

51. (New) A computer-readable medium storing a computer program executable by a computer to perform the following:
receiving transaction data including package shipment cost data, procurement card data, and reference data from a first computer system;
retrieving from a database cost center identification (ID) data corresponding to the procurement card data; and
transmitting the transaction data including the cost data, cost center ID data, and reference data to a second computer system.

52. (New) A computer-readable medium as claimed in claim 51 wherein the computer-readable medium is a memory in a computer system of a procurement card provider.

53. (New) A computer-readable medium as claimed in claim 51 wherein the computer-readable medium is a memory of a computer system of a third party data processor executing the computer program on behalf of a procurement card provider.

54. (New) A computer-readable medium as claimed in claim 51 wherein the computer-readable medium stores transaction data including cost data, the procurement card data, and the reference data, for transmission to a computer system of a procurement card holder.

55. (New) A computer-readable medium storing a computer program executable by a computer to perform the following:
receiving transaction data including package shipment cost data, procurement card data, and reference data;
retrieving from a database cost center identification (ID) data corresponding to the procurement card data; and
transmitting the transaction data including the cost data, cost center ID data, and reference data.

56. (New) A computer-readable medium as claimed in claim 55 wherein the computer-readable medium is a memory within a computer system of a procurement card provider.

57. (New) A computer-readable medium as claimed in claim 55 wherein the computer-readable medium is a memory within a third party data processor executing the computer program on behalf of a procurement card provider.

58. (New) A computer-readable medium as claimed in claim 55 wherein the computer-readable medium is a memory storing shipment cost data, procurement card data, and reference data received from a carrier computer system.

59. (New) A computer-readable medium as claimed in claim 55 wherein the computer-readable medium stores transaction data including the cost data, cost center ID data, and reference data, for transmission to a procurement card holder.

60. (New) A computer-readable medium storing a computer program executable by a computer to perform the following:
entering sender identification (ID) data identifying a sender of a package, shipment data indicating at least one characteristic of the package, and reference data identifying a sub-category of a cost center to which a cost for shipment of a package is to be charged;
transmitting the sender ID data, shipment data, and reference data;
receiving transaction data including cost data generated based on the shipment data, cost center ID data corresponding to the sender ID data, and the reference data;
paying for the shipment cost from the cost center identified by the cost center ID data; and
applying the shipment cost to the cost center and sub-category indicated by the cost center ID data and the reference data, respectively, as an account payable.

61. (New) A computer-readable medium as claimed in claim 60 wherein the computer-readable medium is a memory within a computer system of a procurement card holder.

62. (New) A computer-readable medium as claimed in claim 60 wherein the procurement card holder is an institution.

63. (New) A computer-readable medium as claimed in claim 60 wherein the computer-readable medium stores the sender ID data, shipment data, and reference data for transmission to a carrier computer system via a network.

64. (New) A computer-readable medium as claimed in claim 60 wherein the computer-readable medium stores transaction data, cost center ID data, and reference data that are received from a procurement card provider.

65. (New) A computer-readable medium as claimed in claim 60 wherein the computer-readable medium stores transaction data, the cost center ID data, and the reference data received from a third party data processor operating on behalf of a procurement card provider.
